(19) United States
(12) Patent Application Publication
(10) Pub. No.: US 2011/0187824 A1
(43) Pub. Date: Aug. 4, 2011

(54) ENDOSCOPE APPARATUS AND MEASUREMENT METHOD

(75) Inventor: Fumio HORI, Tokyo (JP)

(73) Assignee: OLYMPUS CORPORATION, Tokyo (JP)

(21) Appl. No.: 12/906,271

(22) Filed: Oct. 18, 2010

(30) Foreign Application Priority Data
Jan. 29, 2010 (JP) P2010-018131

(51) Int. Cl. H04N 13/00

(52) U.S. Cl. 348/45; 348/E13.001

(57) ABSTRACT

An endoscope apparatus, includes: an imaging unit that captures a subject to acquire an image of the subject; a control unit that includes: a base point setting section that sets base points on the image, the base points being used for a three dimensional measurement of the subject; a reference point setting section that sets reference points inside and outside a region based on the base points, the reference points being used for extracting a characteristic of the image; a measurement section that performs the three dimensional measurement of the subject based on the base points; and a generation section that generates characteristic information indicating a characteristic of the image at the reference points based on information on the image at the reference points; and a display that displays the image, the characteristic information, and a result of the three dimensional measurement.

### BACKGROUND OF THE INVENTION

1. Field of the Invention

The present invention relates to an endoscope apparatus with a measurement function. Furthermore, the present invention relates to a method of measuring a subject.

Priority is claimed on Japanese Patent Application No. 2010-018131, filed on Jan. 29, 2010, the content of which is incorporated herein by reference.

2. Description of Related Art

In gas turbines mainly used in aircraft, their internal portions reach a high temperature. This sometimes results in the production of a defect (burning) such as a burn or tarnish on a surface of a turbine blade. The size of the defect is one of the indices for determining whether to replace the blade or not, so the inspection of the defect is extremely important. An endoscope apparatus with a measurement function is used for inspecting blades. In the inspection of blades, the endoscope apparatus measures an area of the defect based on an image where the defect is imaged (hereinafter, referred to as an measurement image) and displays a measurement result (for example, see Japanese Unexamined Patent Application, First Publication No. 2008-206956). A user checks the measurement result, and when the area is large, the user determines that the blade needs replacing because the defect is of a problem. When the area is small, the user determines that the blade does not need replacing because the defect is not of a problem.

### SUMMARY OF THE INVENTION

An endoscope apparatus according to one aspect of the present invention includes: an imaging unit that captures a subject to acquire an image of the subject; a control unit that includes: a base point setting section that sets base points on the image, the base points being used for a three dimensional measurement of the subject; a reference point setting section that sets reference points inside and outside a region based on the base points, the reference points being used for extracting a characteristic of the image; a measurement section that performs the three dimensional measurement of the subject based on the base points; and a generation section that generates characteristic information indicating a characteristic of the image at the reference points based on information on the image at the reference points; and a display that displays the image, the characteristic information, and a result of the three dimensional measurement.

### BRIEF DESCRIPTION OF THE DRAWINGS

FIG. 1 is a block diagram showing a configuration of an endoscope apparatus with a measurement function.

FIG. 2 is a block diagram showing a configuration of a measurement processing portion provided in the endoscope apparatus.

FIG. 3 is a reference diagram showing base points and a base line.

FIG. 4A to FIG. 4C are reference diagrams showing a base ellipse.

FIG. 5A to 5C are reference diagrams showing search points, search areas, and defect composing points.

FIG. 6A and FIG. 6B are reference diagrams showing a defect size.

FIG. 7 is a reference diagram showing a measurement screen (before the start of measurement).

FIG. 8 is a flow chart showing a procedure of measurement.

FIGS. 9A and 9B are reference diagrams showing a measurement screen (at the time of measurement).

FIGS. 10A and 10B are reference diagrams showing a measurement screen (at the time of measurement and on completion of measurement).

FIGS. 11A to 11C are reference diagrams showing a relationship between the position of a cursor and the size of the base ellipse.

FIGS. 12A to 12C are reference diagrams showing a relationship between the position of the cursor and the shape of the base ellipse.

FIG. 13 is a flow chart showing a procedure of a defect calculation.

FIG. 14 is a flow chart showing a procedure of search point computation processing.

FIGS. 15A to 15G are reference diagrams showing a property between the number of search points and their distance.

FIG. 16 is a flow chart showing a procedure of search area computation processing.

FIGS. 17A to 17E are reference diagrams showing a property of the size of a search area.

FIG. 18 is a flow chart showing a procedure of defect composing point computation processing.

FIG. 19 is a reference diagram showing a procedure of defect composing point computation processing.

FIG. 20 is a flow chart showing a procedure of defect size computation processing.

FIG. 21 is a reference diagram for explaining a method of finding three-dimensional coordinates of a measurement point using the stereo measurement.

FIG. 22 is a block diagram showing a configuration of a measurement processing portion provided in an endoscope apparatus according to a first embodiment of the present invention.

FIG. 23 is a flow chart showing a procedure of measurement in the first embodiment of the present invention.

FIG. 24 is a flow chart showing a procedure of a defect calculation in the first embodiment of the present invention.

FIG. 25 is a flow chart showing a procedure of computation processing of a defect diagnosis result in the first embodiment of the present invention.

FIGS. 26A to 26D are reference diagrams showing reference points and reference areas in the first embodiment of the present invention.

FIG. 27 is a reference diagram showing a measurement screen (on completion of measurement) in the first embodiment of the present invention.

FIGS. 28A to 28C are reference diagrams showing a computation method of reference points in the first embodiment of the present invention.

FIG. 29 is a block diagram showing a configuration of a measurement processing portion provided in an endoscope apparatus according to a second embodiment of the present invention.

FIG. 30 is a flow chart showing a procedure of measurement in the second embodiment of the present invention.

FIGS. 31A to 31E are reference diagram showing how to specify base points in the second embodiment of the present invention.

FIG. 32 is a flow chart showing a procedure of a defect calculation in the second embodiment of the present invention.

FIG. 33 is a flow chart showing a procedure of computation processing of a defect diagnosis result in the second embodiment of the present invention.

FIGS. 34A to 34C are reference diagram showing a computation method of reference points in the second embodiment of the present invention.

FIG. 35 is a reference diagram showing a measurement screen (on completion of measurement) in the second embodiment of the present invention.

### DETAILED DESCRIPTION OF THE INVENTION

Hereunder is a description of embodiments of the present invention with reference to the drawings.

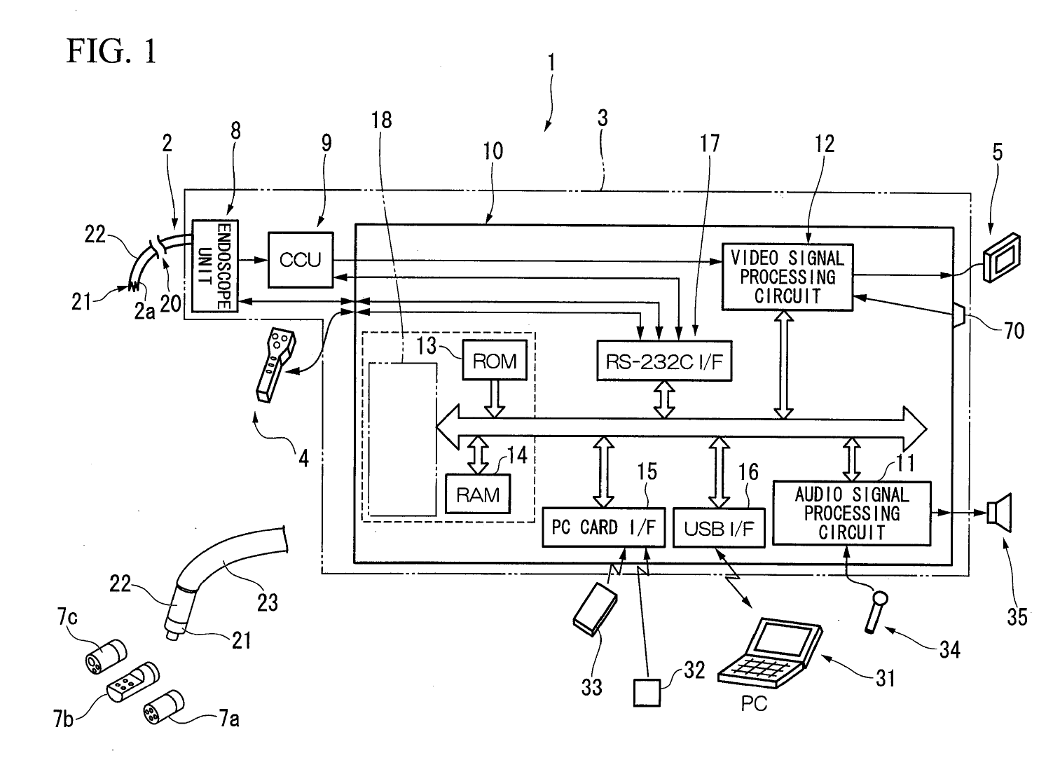

First, an embodiment of an endoscope apparatus with a measurement function will be described. Hereunder is a description of a measurement function of a defect for the case where burning of a turbine blade is a measurement target, by way of example. FIG. 1 shows a configuration of an endoscope apparatus. As shown in FIG. 1, an endoscope apparatus 1 includes: an endoscope 2; a main unit 3; a remote controller 4 (input device); a liquid crystal monitor 5; optical adapters 7a, 7b, and 7c; an endoscope unit 8; a camera control unit 9; and a control unit 10.

The endoscope 2 (videoscope), which captures an image of a measurement target to generate its image signal, includes a long and thin insertion portion 20. The insertion portion 20 includes: a rigid distal portion 21; a bent portion 22 capable of being bent, for example, in the vertical and horizontal directions; and a flexible tube portion 23, which are coupled in this order from the distal side. The proximal portion of the insertion portion 20 is connected to the endoscope unit 8. Various optical adapters, such as the optical adapter 7a or 7b for stereo having two observation fields of view (hereinafter, referred to as stereo optical adapter) or the normal observation optical adapter 7c having only one observation field of view, can be attached to the distal portion 21 in a freely detachably manner by, for example, threading.

The main unit 3 includes the endoscope unit 8; the camera control unit (hereinafter, referred to as CCU) 9 as an image processing device; and the control unit 10 as a control device. The endoscope unit 8 includes: a light source apparatus for supplying necessary illumination light at the time of observation; and a bending apparatus for bending the bent portion 22 that constitutes the insertion portion 20. The CCU 9 receives an image signal output from a solid-state imaging device 2a built in the distal portion 21 of the insertion portion 20, converts the image signal into a video signal such as an NTSC signal, and supplies it to the control unit 10. The solid-state imaging device 2a generates an image signal by performing photoelectric conversion on a subject image that has been formed through the optical adapter.

The control unit 10 includes: an audio signal processing circuit 11; a video signal processing circuit 12; a ROM 13; a RAM 14; a PC card interface (hereinafter, referred to as PC card I/F) 15; a USB interface (hereinafter, referred to as USB I/F) 16; an RS-232C interface (hereinafter, referred to as RS-232C I/F) 17; and a measurement processing portion 18.

An audio signal generated by collecting sound with the microphone 34, an audio signal obtained by playing a recording medium such as a memory card, or an audio signal generated by the measurement processing portion 18 is supplied to the audio signal processing circuit 11. To display a synthesized image obtained by synthesizing the endoscope image supplied from the CCU 9 with a graphical operation menu, the video signal processing circuit 12 performs processing of synthesizing the video signal from the CCU 9 with a graphic image signal such as an operation menu generated through the control by the measurement processing portion 18. In addition, to display a video on the screen of the liquid crystal monitor 5, the video signal processing circuit 12 subjects the video signal after the synthesis to predetermined processing, and supplies it to the liquid crystal monitor 5.

The video signal processing circuit 12 outputs image data, which is based on the video signal from the CCU 9, to the measurement processing portion 18. At the time of measurement, a stereo optical adapter is attached to the distal portion 21, and a plurality of subject images relating to the same subject as a measurement target are included in the image based on the image data from the video signal processing circuit 12. In the present embodiment, a pair of left and right subject images is included, by way of example.

A memory card (recording medium) such as a PCMCIA memory card 32 or a flash memory card 33 is freely attached to or detached from the PC card I/F 15. When the memory card is attached to the PC card I/F 15, control processing information, image information, optical data, or the like that is stored in the memory card can be taken in, or control processing information, image information, optical data, or the like can be stored in memory card, in accordance with the control of the measurement processing portion 18.

The USB I/F 16 is an interface which electrically connects the main unit 3 and a personal computer (PC) 31 to each other. When the main unit 3 and the personal computer 31 are connected to each other through the USB I/F 16, it is possible to perform various kinds of instruction and controls, such as an instruction to display an endoscope image or an image processing during measurement, at the personal computer 31 side. In addition, it is possible to input and output various pieces of processing information, data and the like between the main unit 3 and the personal computer 31.

The RS-232C I/F 17 is connected to the CCU 9, the endoscope unit 8, and the remote controller 4 which performs control and operation instructions of the CCU 9, the endoscope unit 8, and the like. When a user operates the remote controller 4, a communication required for controlling the CCU 9 and the endoscope unit 8 is performed in accordance with the type of the operation.

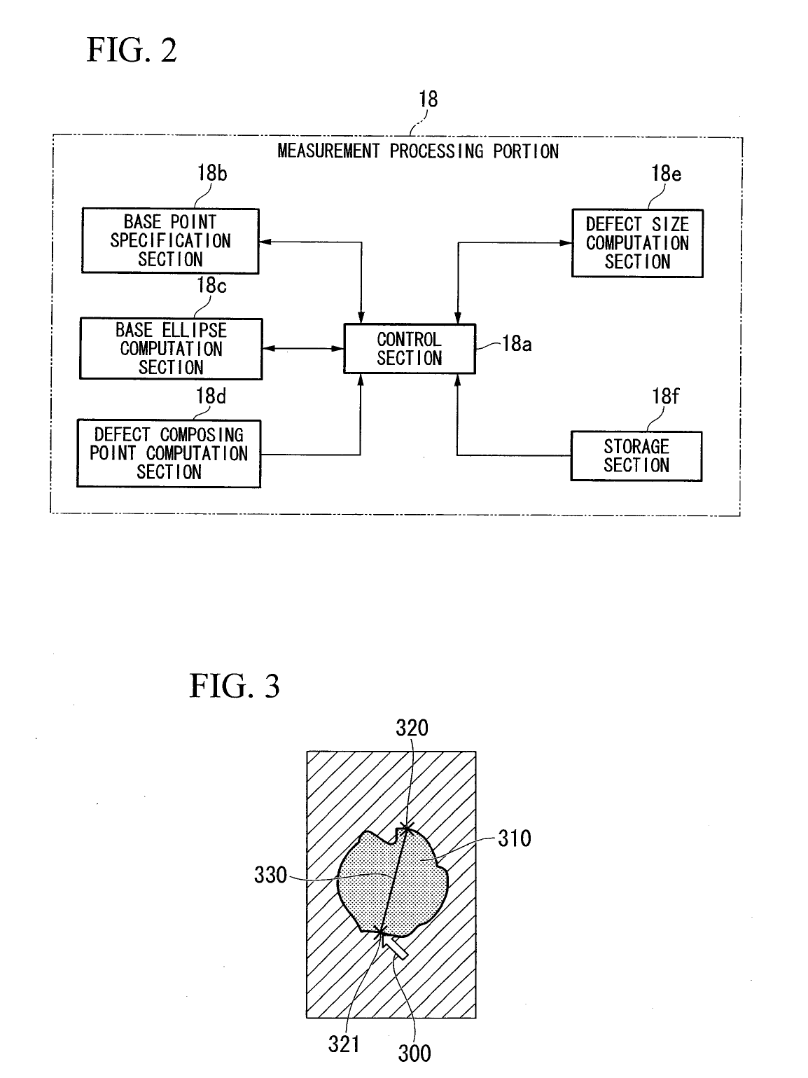

The measurement processing portion 18 executes a program stored in the ROM 13, to thereby take in the image data from the video signal processing circuit 12 and perform measurement processing based on the image data. The RAM 14 is used by the measurement processing portion 18 as a work area for temporarily storing data. FIG. 2 shows a configuration of the measurement processing portion 18. As shown in FIG. 2, the measurement processing portion 18 includes: a control section 18a; a base point specification section 18b; a base ellipse computation section 18c; a defect composing point computation section 18d; a defect size computation section 18e; and a storage section 18f.

The control section 18a controls the various sections of the measurement processing portion 18. Furthermore, the control section 18a has a function of generating a graphic image signal for displaying the measurement result, the operation menu, and the like on the liquid crystal monitor 5, and of outputting the graphic image signal to the video signal processing circuit 12.

The base point specification section 18b specifies base points (the details of which will be described later) on a measurement target based on a signal input from the remote controller 4 or the PC 31 (input portion). When the user inputs a desired base point while looking at the image of the measurement target displayed on the liquid crystal monitor 5, its coordinates are computed by the base point specification section 18b. In the following description, it is assumed that the user operates the remote controller 4. However, the same applies to the case where the user operates the PC 31.

Based on the base points specified by the base point specification section 18b, the base ellipse computation section 18c computes a base ellipse (the detail of which will be described later) corresponding to an approximated outline that approximates to an outline of the measurement target. Based on the base points and the base ellipse, the defect composing point computation section 18d computes defect composing points (the detail of which will be described later) that constitutes an edge (an outline) of the defect formed in the measurement target.

The defect size computation section 18e measures a size of the defect based on the defect composing points. The storage section 18f stores various pieces of information that are processed in the measurement processing portion 18. The various pieces of information stored in the storage section 18f are appropriately read by the control section 18a and are then output to the appropriate sections.

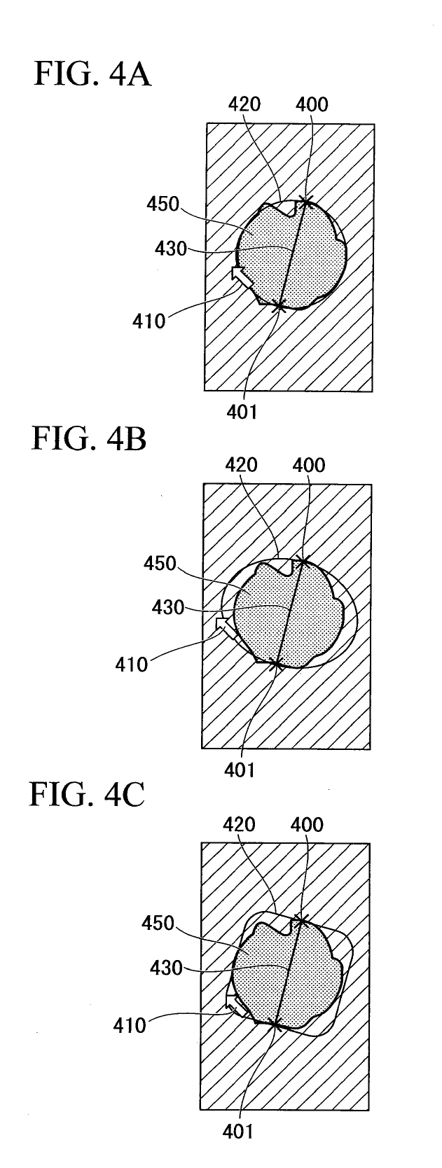

Next is a description of the terms used in the present specification. First, the terms “base point,” “base line,” and “base ellipse” will be described with reference to FIG. 3 and FIGS. 4A to 4C. A base point is a point on the measurement screen actually specified by the user. While looking at the measurement screen, the user operates the remote controller 4 to specify a base point. As shown in FIG. 3, a cursor 300 showing a specified position is displayed on the measurement screen. The cursor 300 is moved in accordance with the operation on the remote controller 4 by the user. When the user inputs an instruction for specifying a base point in a state with the cursor 300 having been moved to a desired position, the base point is set to the position of the cursor 300. Subsequently, the user moves the cursor 300, and specifies a next base point similarly. In the present embodiment, three base points are sequentially specified. At first, the user specifies two base points 320, 321 located on both ends of a defect 310, as shown in FIG. 3.

A base line is a line formed by connecting the first base point and the second base point that have been specified on the measurement screen by the user. As shown in FIG. 3, a line 330 that connects the base points 320, 321 is a base line. A base ellipse is an ellipse that is set and displayed on the measurement screen when the user specifies a third base point. The ellipse corresponds to a curve that approximates the edge of the defect. As shown in FIGS. 4A to 4C, when base points 400, 401 are specified, a base ellipse 420 that passes through the positions of the base points 400, 401 is displayed. The base ellipse 420 has a base line 430 as one diameter, and the other diameter and curvature of the reference ellipse 420 are changed in accordance with the position of a cursor 410. The user adjusts the position of the cursor 410 so that the shape of the base ellipse 420 matches that of a defect 450 as closely as possible, and then inputs an instruction for specifying a third base point.

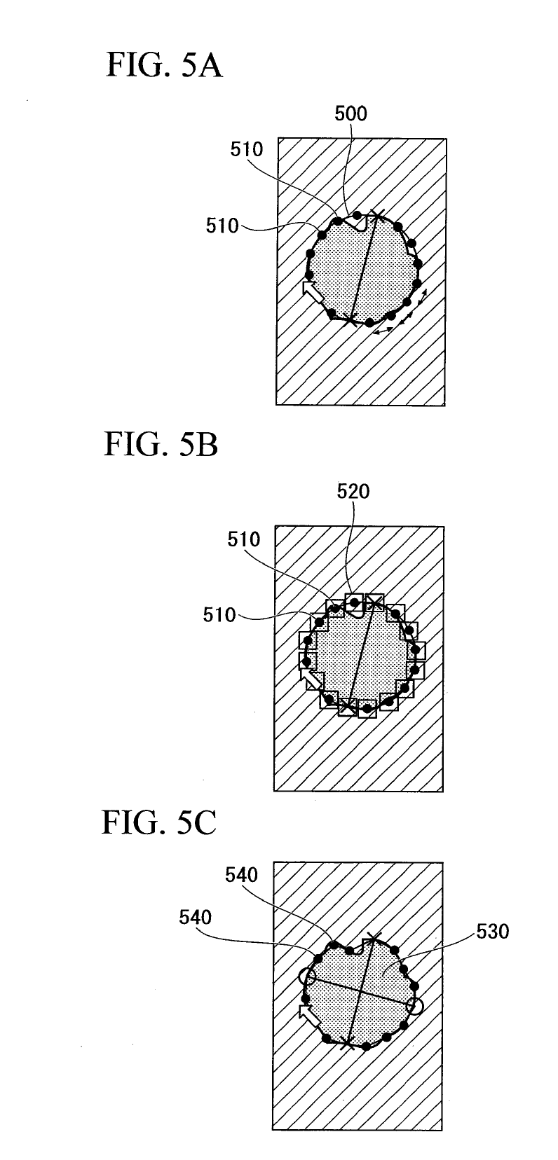

Next, the terms “search point,” “search area,” and “defect composing point” will be described with reference to FIGS. 5A to 5C. The search points are points that are set on the base ellipse in an evenly spaced manner. The search area is set around each search point, which will be described later. As shown in FIG. 5A, search points 510 are set on a base ellipse 500 in an evenly spaced manner. The first and second base points specified by the user are included in the search points. As will be described later, the number of and the distance between the search points vary according to the size of the base ellipse.

The search area is a rectangular range which is located around the search point. Image processing is performed on the search area to compute defect composing points (described later). As shown in FIG. 5B, a square search area 520 is set around each search point 510. As will be described later, the size of the search area varies according to the size of the base ellipse. The shape of the search area is not limited to a square.

The defect composing points are points that constitute an edge of a defect as a region of a measurement target. As shown in FIG. 5C, defect composing points 540 are set on an edge of a defect 530. As will be described later, defect composing points are found by performing image processing on the measurement images of the search areas.

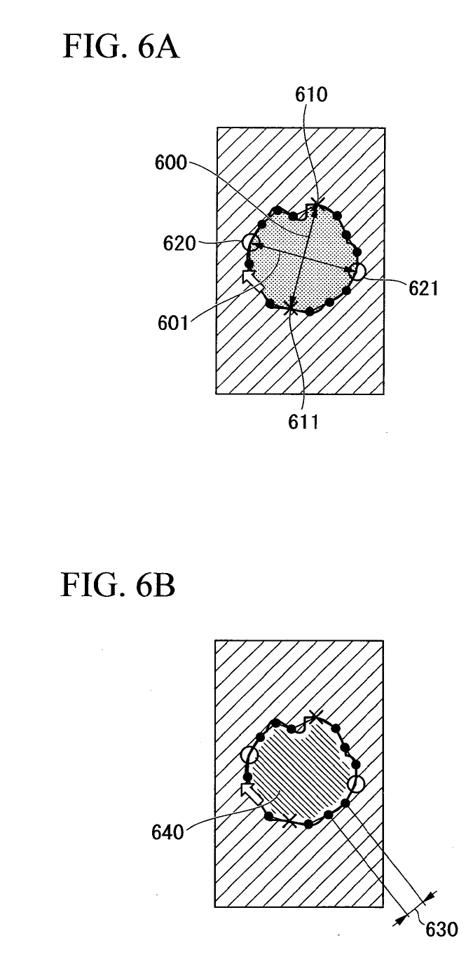

Next, the term “defect size” will be described with reference to FIG. 6A and FIG. 6B. The defect size is a parameter that denotes a size of a detected defect. The defect size computed in the present embodiment includes two types of widths, a perimeter length, and an area of the defect. To be more specific, one width of the defect is a spatial distance (three-dimensional distance) between the two defect composing points that correspond to the first and second base points specified by the user. The other width of the defect is a spatial distance between the two defect composing points that correspond to two search points on a line generally orthogonal to the base line. The perimeter length is a sum total of spatial distances between all the adjacent defect composing points. The area is a spatial area of a region surrounded by all the defect composing points.

As shown in FIG. 6A, one width 600 of a defect is computed as a spatial distance between two defect composing points that correspond to base points 610, 611. The other width 601 of the defect is computed as a spatial distance between two defect composing points that correspond to search points 620, 621 on a line generally orthogonal to the base line. In the present embodiment, search points are computed so as to include the search points 620, 621 on the line generally orthogonal to the base line. As shown in FIG. 6B, the perimeter length is computed as a sum total of spatial distances 630 between all the adjacent defect composing points. The area is computed as a spatial area of a region 640 surrounded by all the defect composing points.

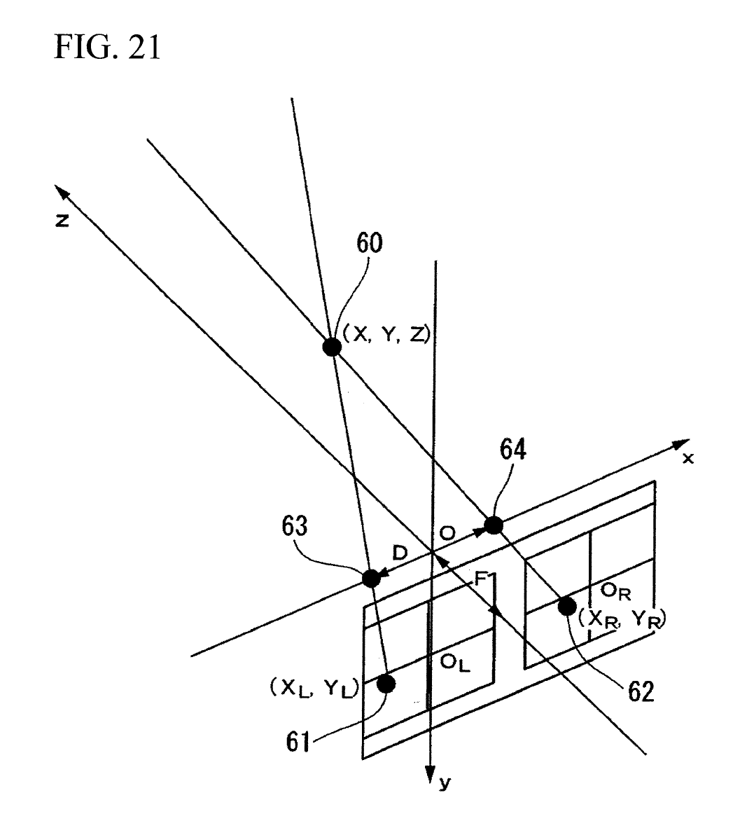

Next, the way of calculating three-dimensional coordinates of a measurement point by the stereo measurement will be described with reference to FIG. 21. For images that are imaged by the left side and right side optical systems, three-dimensional coordinates (X, Y, Z) of a measurement target point 60 are calculated by the triangulation method using the following Equations (1) to (3). Note that it is assumed that the coordinates of a measurement point 61 and a corresponding point 62 (a point on the right image that corresponds to the measurement point 61 on the left image) on the left and right images that have been subjected to distortion correction are (X_{L}, Y_{L}) and (X_{R}, Y_{R}), respectively, the distance between optical centers 63 and 64 on the left side and the right side is D, the focal length is F, and t=D/(X_{L}−X_{R}).

X=t×X_{R}+D/2 (1)

Y=t×Y_{R} (2)

Z=t×F (3)

When the coordinates of the measurement point 61 and the corresponding point 62 on are determined in the aforementioned manner, the three-dimensional coordinates of the measurement target point 60 are found using the parameters D and F. By calculating the three-dimensional coordinates of a number of points, various measurements such as a point-to-point distance, the distance between a line connecting two points and one point, surface area, depth, and surface shape, are possible. Furthermore, it is possible to calculate the distance (object distance) from the left-side optical center 63 or the right-side optical center 64 to the subject. In order to carry out the aforementioned stereo measurement, optical data that shows the characteristics of the optical system including the distal portion 21 and the stereo optical adaptor are required. Note that the details of the optical data are disclosed, for example, in Japanese Unexamined Patent Application, First Publication No. 2004-49638, so an explanation thereof will be omitted here.

Although the stereo measurement is employed as a method of measuring three-dimensional coordinates in the present embodiment, other three-dimensional coordinate measurement methods capable of calculating three-dimensional coordinates based on the subject image, such as the pattern projection method (phase shift method, light section method or the like) may be employed.

Next is a description of a measurement screen in the present embodiment. In the present embodiment, measurement of a defect is performed by using the stereo measurement. In the stereo measurement, a measurement target is imaged in a state with the stereo optical adapter attached to the distal portion 21 of the endoscope 2. Therefore, a pair of left and right images of the measurement target is displayed on the measurement screen.

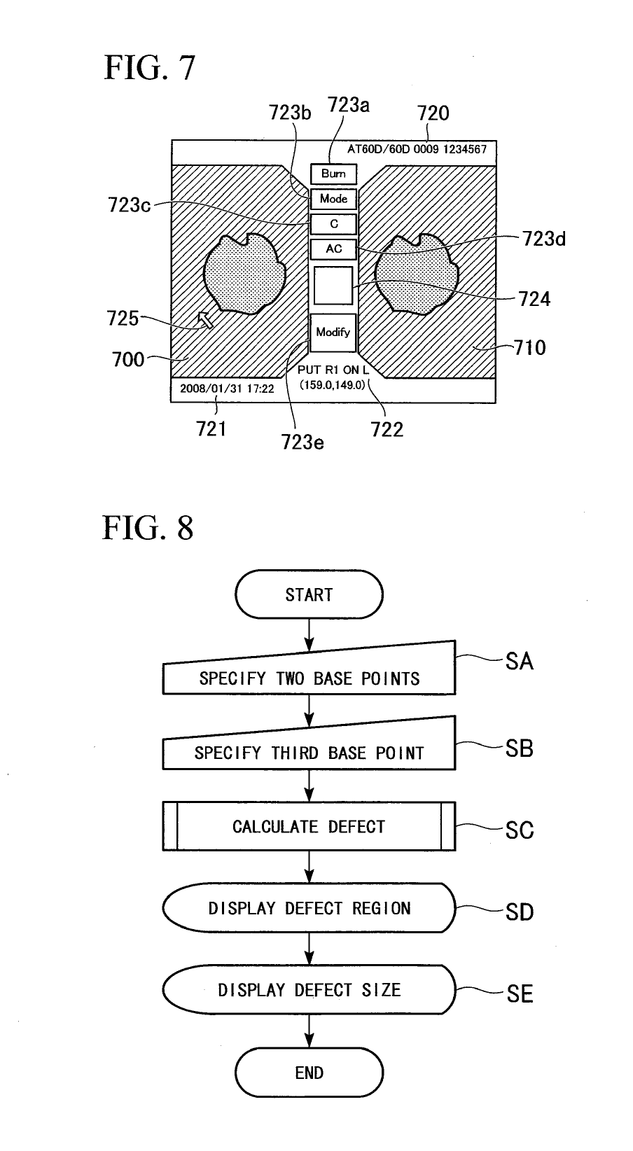

FIG. 7 shows a measurement screen before the start of measurement. As measurement information, a left image of the measurement target is displayed on a left screen 700, and a right image of the measurement target is displayed on a right screen 710. Optical adapter name information 720, time information 721, message information 722, icons 723a, 723b, 723c, 723d, and 723e, and a zoom window 724 are displayed on the measurement screen in a region outside the left screen 700 and the right screen 710, as other pieces of measurement information.

The optical adapter name information 720 and the time information 721 are pieces of information showing measurement conditions. The optical adapter name information 720 is textual information showing the name of the optical adapter in current use. The time information 721 is textual information showing the current date and time. The message information 722 includes: textual information showing an operational instruction for the user; and textual information showing the coordinates of a base point, which is one of the measurement conditions.

The icons 723a to 723e constitute an operation menu for the user to input operational instructions such as switching measurement modes and clearing a measurement result. When the user operates the remote controller 4 to move a cursor 725 onto any of the icons 723a to 723e and performs an operation such as a click in this state, a signal corresponding to the operation is input to the measurement processing portion 18. Based on the signal, the control section 18a recognizes the operational instruction from the user, and controls the measurement processing. In addition, an enlarged image of the measurement target located around the cursor 725 is displayed on the zoom window 724.

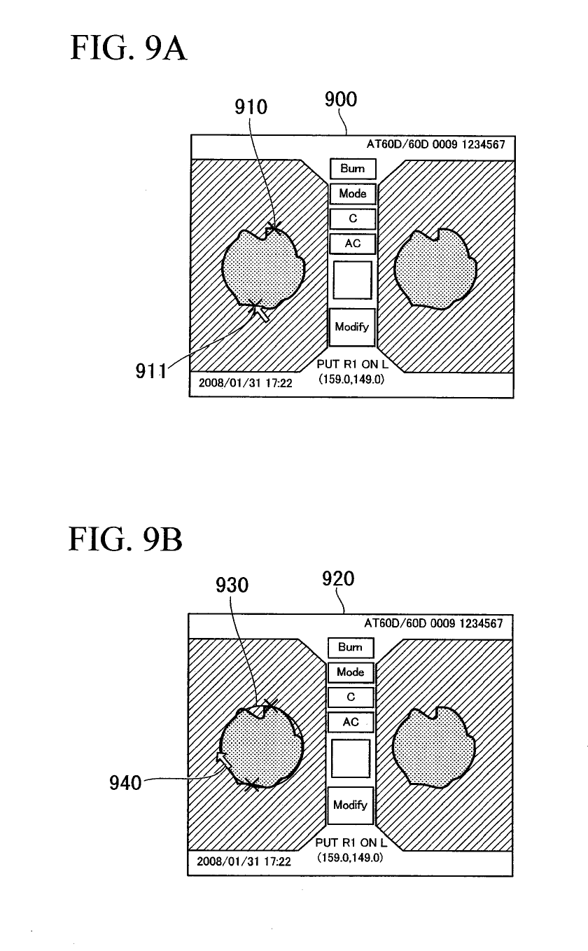

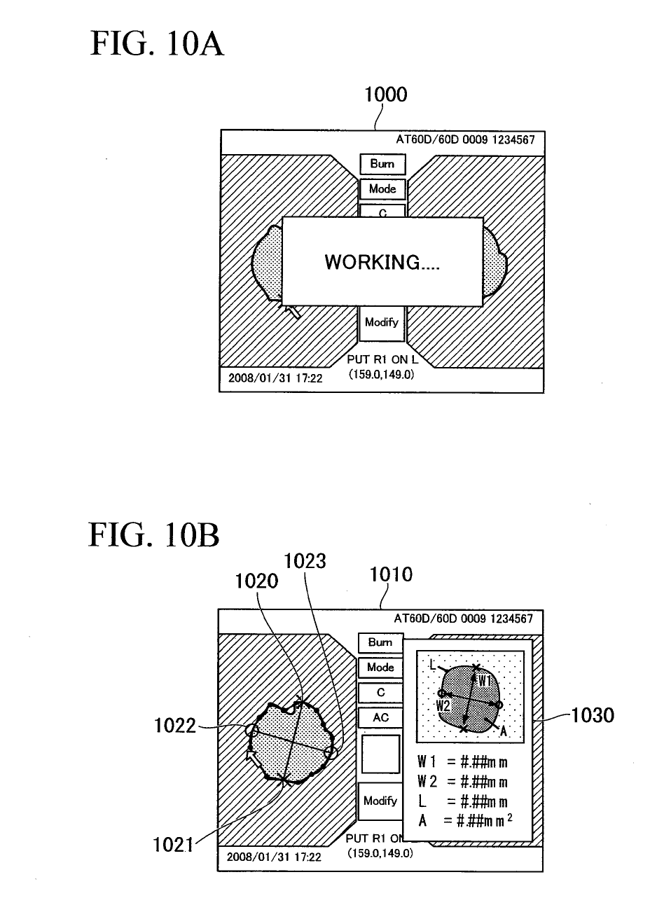

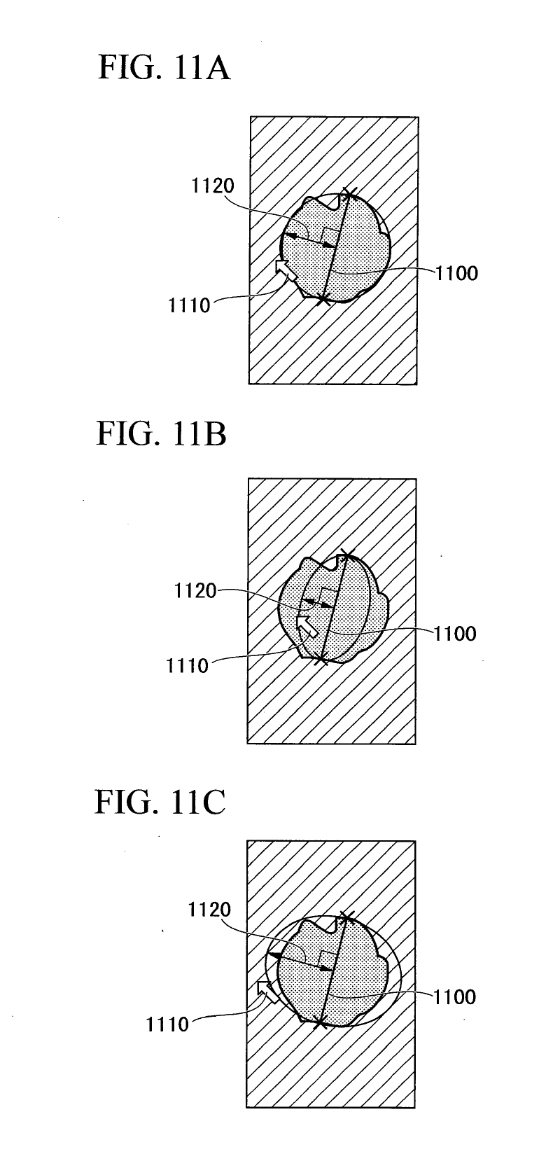

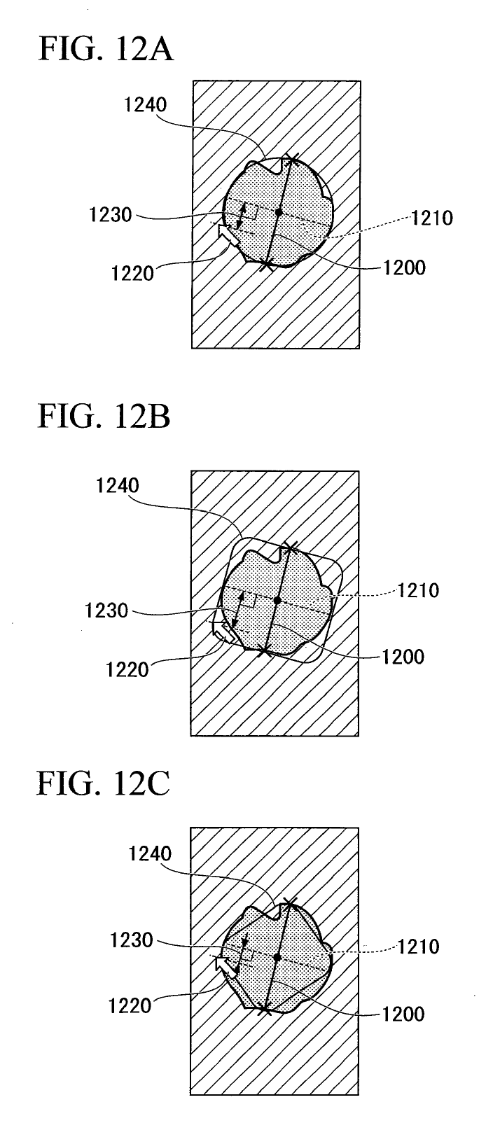

Next, a procedure of measurement in the present embodiment will be described with reference to FIG. 8 to FIG. 12C. FIG. 8 shows a procedure of measurement. FIG. 9A to FIG. 10B show a measurement screen. FIGS. 11A to 11C show a relationship between the position of the cursor and the size of the base ellipse. FIGS. 12A to 12C show a relationship between the position of the cursor and the shape of the base ellipse.

First, when the user operates the remote controller 4 to specify two base points on the measurement screen displayed on the liquid crystal monitor 5, the information on the specified base points is input to the measurement processing portion 18 (Step SA). At this time, it is desirable that the user select points located at both ends on the edge of the defect as base points. As shown in FIG. 9A, when base points 910, 911 are specified on a left image of a measurement screen 900, “x” marks are displayed at the base points 910, 911.

When the position information on the two base points on the left screen specified by the user is input to the measurement processing portion 18, the base point specification section 18b computes image coordinates (two-dimensional coordinates on the image displayed on the liquid crystal monitor 5) of the two base points. The computed image coordinates of the two base points are output to the base ellipse computation section 18c. Furthermore, image coordinates at the cursor position are computed in a similar manner to the above and are output to the base ellipse computation section 18c. The base ellipse computation section 18c computes a base ellipse based on the image coordinates of the two base points and the cursor position, and outputs information on the base ellipse (the image coordinates of the points constituting the base ellipse or the formula representing the base ellipse) to the control section 18a. The control section 18a performs processing of drawing the base ellipse. As a result, a base ellipse is displayed on the measurement screen.

The size and shape of the base ellipse vary according to the position of the cursor. When the user inputs an instruction for specifying a third base point in a state with the shape of the base ellipse in as close agreement as possible with that of the defect, the information on the specified base points is input to the measurement processing portion 18 (Step SB). As shown in FIG. 9B, a base ellipse 930 is displayed on a measurement screen 920, and a third base point is specified at the position of a cursor 940. At this time, image coordinates of the third base point are computed by the base point specification section 18b in a similar manner to the above.

Details of the relationship between the position of the cursor and the size/shape of the base ellipse are as follows. One diameter of the base ellipse is the same as the base line, and is fixed no matter where the cursor is located. The other diameter of the base ellipse is twice as long as the distance between the base line and the cursor, and varies according to the position of the cursor. FIGS. 11A to 11C show how the other diameter of the base ellipse varies according to the position of the cursor. As shown in FIG. 11B, when a distance 1120 between a base line 1100 and a cursor 1110 is shorter than that in FIG. 11A, the other diameter becomes shorter. On the other hand, as shown in FIG. 11C, when the distance 1120 between the base line 1100 and the cursor 1110 is longer than that in FIG. 11A, the other diameter becomes longer.

The shape of the base ellipse varies according to the distance between the cursor and a line that passes through the midpoint of the base line and is generally perpendicular to the base line. To be more specific, the base ellipse varies in curvature according to the distance, leading to a variation in shape. FIGS. 12A to 12C show how the shape of the base ellipse varies according to the position of the cursor. As shown in FIGS. 12B and 12C, when a distance 1230 between a cursor 1220 and a perpendicular line 1210 which passes through a midpoint of the two base points and is generally perpendicular to a base line 1200 is much longer or shorter than that in FIG. 12A, the shape of a base ellipse 1240 is closer to a rectangle. As described above, it is possible to flexibly set the size and shape of the base ellipse according to the position of the cursor.

After the third base point is specified, the measurement processing portion 18 performs a defect calculation based on the coordinates of the specified base points (Step SC). In the defect calculation, coordinates of defect composing points and defect size are computed. A measurement screen 1000 shown in FIG. 10A is a measurement screen during the defect calculation. Details of the defect calculation will be described later. As will be described later, there are cases where search points are not computed depending on the coordinates of the specified base points. In this case, even if base points are specified, the defect calculation will not be started.

On completion of the defect calculation, a detected defect region is displayed on the measurement screen through the instruction from the measurement processing portion 18 (Step SD). As shown in FIG. 10B, a defect region is displayed on a left screen of a measurement screen 1010. To be more specific, the computed defect composing points are displayed with small filled circles, “x” marks, and unfilled circles, which are connected by a line. Two defect composing points 1020, 1021 indicated with an “x” mark are the defect composing points that correspond to the first and second base points specified by the user. Two defect composing points 1022, 1023 denoted with an unfilled circle are the defect composing points that correspond to two points on the line generally perpendicular to the base line.

Furthermore, a computed defect size is displayed on the measurement screen through the instruction from the measurement processing portion 18 (Step SE). As shown in FIG. 10B, a defect size is displayed on a result window 1030 of a right screen of the measurement screen 1010. An image of the defect is displayed in the upper portion of the result window 1030, and the defect size in text is displayed in the lower portion of the result window 1030. W1, W2, L, and A denote one width, the other width, the perimeter length, and the size of the defect, respectively.

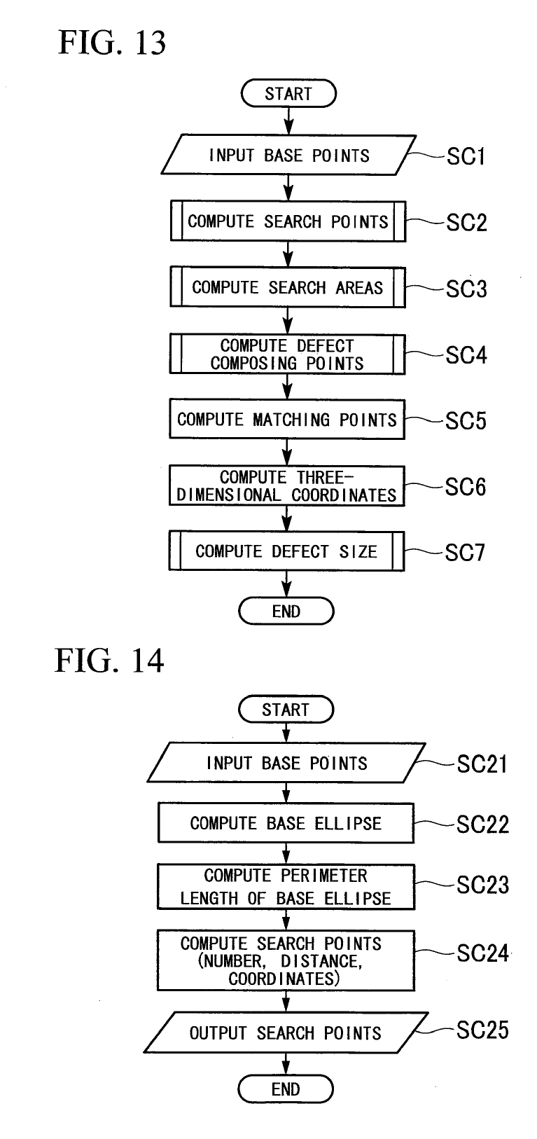

Next, a procedure of the defect calculation in Step SC of FIG. 8 will be described with reference to FIG. 13. When the image coordinates of the three base points computed by the base point specification section 18b are input to the base ellipse computation section 18c (Step SC1), the base ellipse computation section 18c computes search points based on the image coordinates of the three base points (Step SC2). Details of the computation of the search points will be described later.

Subsequently, the base ellipse computation section 18c computes search areas based on the information on the search points (Step SC3). Details of the computation of the search areas will be described later. Subsequently, the defect composing point computation section 18d computes image coordinates of defect composing points based on the information on the search points and the search areas (Step SC4). Details of the computation on the defect composing points will be described later.

Subsequently, the defect composing point computation section 18d computes image coordinates of matching points on the right screen that correspond to the computed defect composing points on the left screen (Step SC5). To be more specific, the defect composing point computation section 18d executes pattern-matching processing based on the image coordinates of the defect composing points to compute matching points as corresponding points on the left and right images. The method of the pattern-matching processing is similar to that described in Japanese Unexamined Patent Application, First Publication No. 2004-49638.

Subsequently, the defect composing point computation section 18d computes spatial coordinates (three-dimensional coordinates in the actual space) of the defect composing points based on the image coordinates of the computed defect composing points and their matching points (Step SC6). A calculation method of the spatial coordinates is similar to the above-described method with reference to FIG. 21.

Lastly, the defect size computation section 18e computes a defect size based on the spatial coordinates of the computed defect composing points (Step SC7). Details of the computation of the defect size will be described later.

Next, a procedure of the search point computation processing (Step SC2) will be described with reference to FIG. 14. When the image coordinates of the three base points are input from the control section 18a (Step SC21), the base ellipse computation section 18c computes a base ellipse based on the input image coordinates of the base points (Step SC22). The base ellipse that is computed at this time is the same as that displayed when the third base point is specified in Step SC of FIG. 8.

Subsequently, the base ellipse computation section 18c computes a perimeter length of the base ellipse. To be more specific, the base ellipse computation section 18c uses image coordinates of pixels that constitute the base ellipse to find a total value of two-dimensional distances between the adjacent pixels, to thereby compute the perimeter length of the base ellipse (Step SC23). Subsequently, the base ellipse computation section 18c computes the number of, the distances between, and the image coordinates of the search points (Step SC24). Lastly, the base ellipse computation section 18c outputs information on the search points (the number of, the distances between, and the image coordinates of the search points) to the control section 18a (Step SC25). However, when the computation of the search points fails, the number of the search points is set to 0.

The computation of the search points is carried out based on the following conditions (A) to (H).

(A): The first and second base points specified by the user are included in the search points.

(B): The search points are set on the base ellipse in an evenly spaced manner.

(C): The number of and the distance between the search points are proportional to the perimeter length of the base ellipse.

(D): The number of the search points has an upper limit.

(E): The distance between the search points has a lower limit.

(F): When the perimeter length of the base ellipse is very short, the search points are not computed.

(G): When the distance between the first and second base points specified by the user is very short, the search points are not computed.

(H): When the distance between the third base point specified by the user and the base line is very short, the search points are not computed.

The reasons for setting the above conditions (C) to (H) are respectively shown as (C′) to (H′) below.

(C′): In order to prevent the search areas from mutually overlapping.

(D′): When the number of the search points is too large, it takes too much time to compute the defect composing points.

(E′): When the distance between the search points is too short, the size of the search areas is too small, which is unfavorable for the computation of the defect composing points.

(F′) to (H′): similar to (C′).

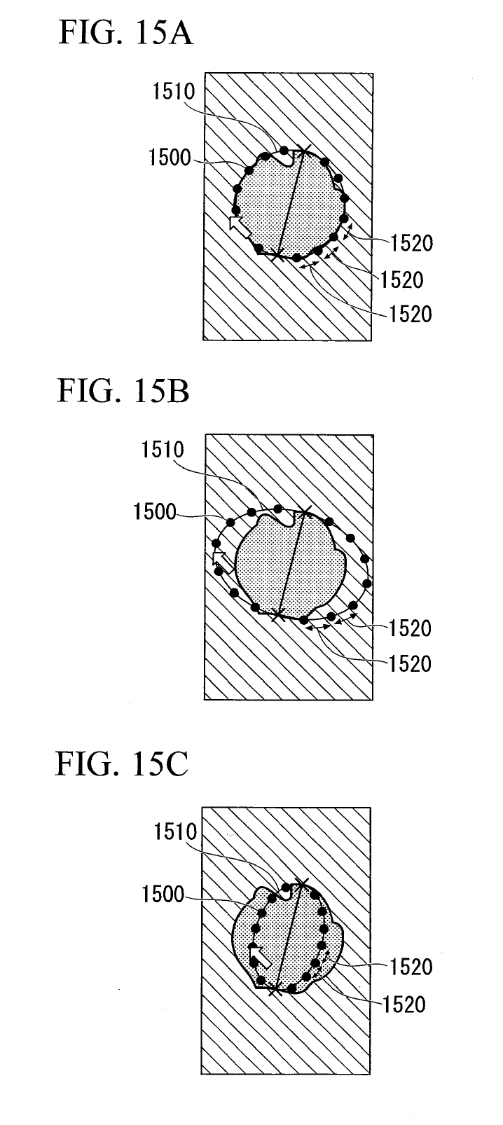

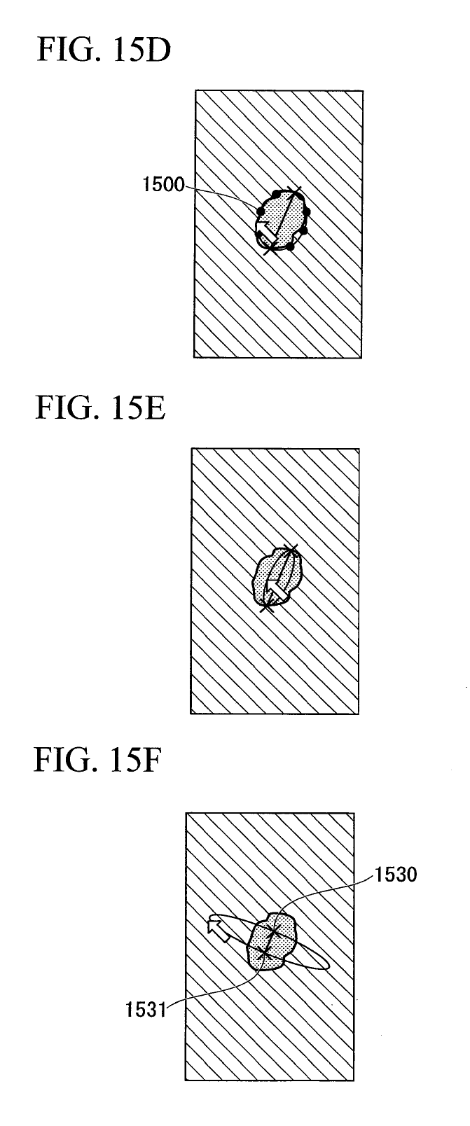

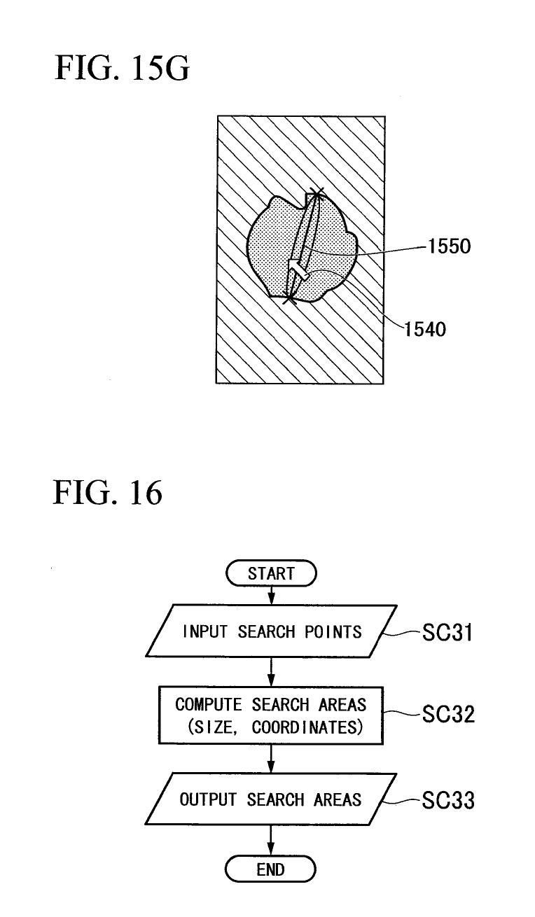

The number of and the distance between the search points computed based on the above conditions show the following properties. FIG. 15A shows that search points 1500 are located on a base ellipse 1510 in an evenly spaced manner. As shown in FIG. 15B, when the perimeter length is longer than that of FIG. 15A, distances 1520 between the search points 1500 are proportionally longer. On the other hand, as shown in FIG. 15C, when the perimeter length is shorter than that of FIG. 15A, the distances 1520 between the search points 1500 are proportionally shorter.

As shown in FIG. 15D, when the perimeter length is less than a predetermined first perimeter length, the number of the search points 1500 is smaller. As shown in FIG. 15E, when the perimeter length is less than a predetermined second perimeter length (the second perimeter length is shorter than the first perimeter length), the search points are not computed. Furthermore, as shown in FIG. 15F, when a distance between base points 1530, 1531 is very short, the search points are not computed. As shown in FIG. 15G, when a distance between a third base point specified by the user (a position of a cursor 1540) and a base line 1550 is very short, the search points are not computed. Although the search points are evenly spaced in the present embodiment, they may not be evenly spaced.

Next, a procedure of the search area computation processing (Step SC3) will be described with reference to FIG. 16. When the information on the search points is input from the control section 18a (Step SC31), the base ellipse computation section 18c computes the number and the image coordinates of the search areas based on the input information on the search points (Step SC32). Lastly, the base ellipse computation section 18c outputs information on the search areas (the number and the image coordinates of the search areas) to the control section 18a (Step SC33).

Computation of the search areas is performed based on the following conditions (a) to (e).

(a): The search area is located around each search point.

(b): The search area has a shape of a square.

(c): The size of the search areas is set so as not to allow the search areas to mutually overlap, and is proportional to the distance between the search points.

(d): The size of the search area has an upper limit

(e): The size of the search area has a lower limit.

The reasons for setting the above conditions (c) to (e) are respectively shown as (c′) to (e′) below.

(c′): When the search areas mutually overlap, the defect composing points are computed in the same region, leading to a possibility that the edge of the detected defect is twisted.

(d′): Too large the size of the search areas requires too much time for image processing, and is also unfavorable for computation of the defect composing points.

(e′) Too small the size of the search areas is unfavorable for computation of the defect composing points.

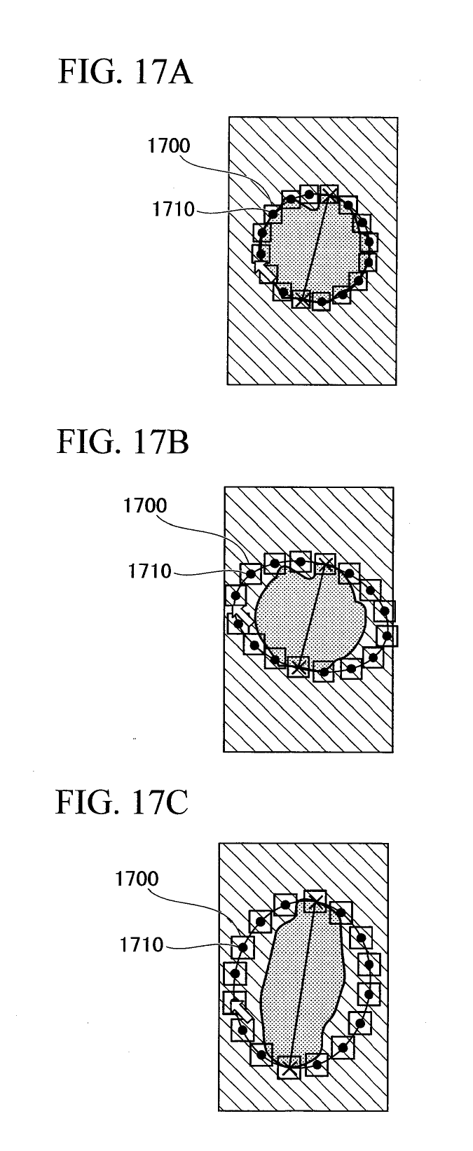

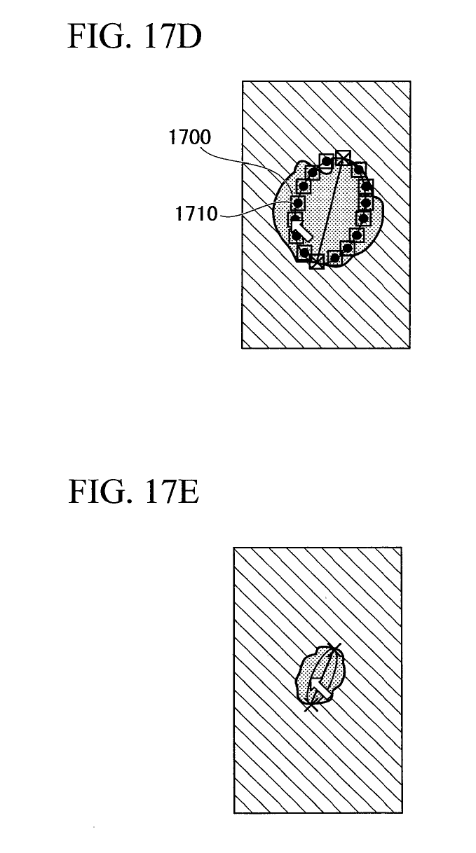

The size of the search areas computed based on the above conditions shows the following properties. FIG. 17A shows that search areas 1700 are set around search points 1710. As shown in FIG. 17B, when the distance between the search points 1710 is longer than that of FIG. 17A, the size of the search areas 1700 is proportionally larger. The search areas 1700 at this time have a size that does not allow their mutual overlapping. As shown in FIG. 17C, when the distance between the search points 1710 is still longer than that of FIG. 17B, the size of the search areas 1700 reaches its upper limit.

On the other hand, as shown in FIG. 17D, when the distance between the search points 1710 is shorter than that of FIG. 17A, the size of the search areas 1700 is proportionally smaller. The search areas 1700 at this time have a size that does not allow their mutual overlapping. When the distance between the search points 1710 is still shorter, the size of the search areas 1700 reaches its lower limit. When the distance between the search points 1710 is less than this limit, the search points are deleted as shown in FIG. 17E. Although the search areas are square in the present embodiment, their shape may not be a square.

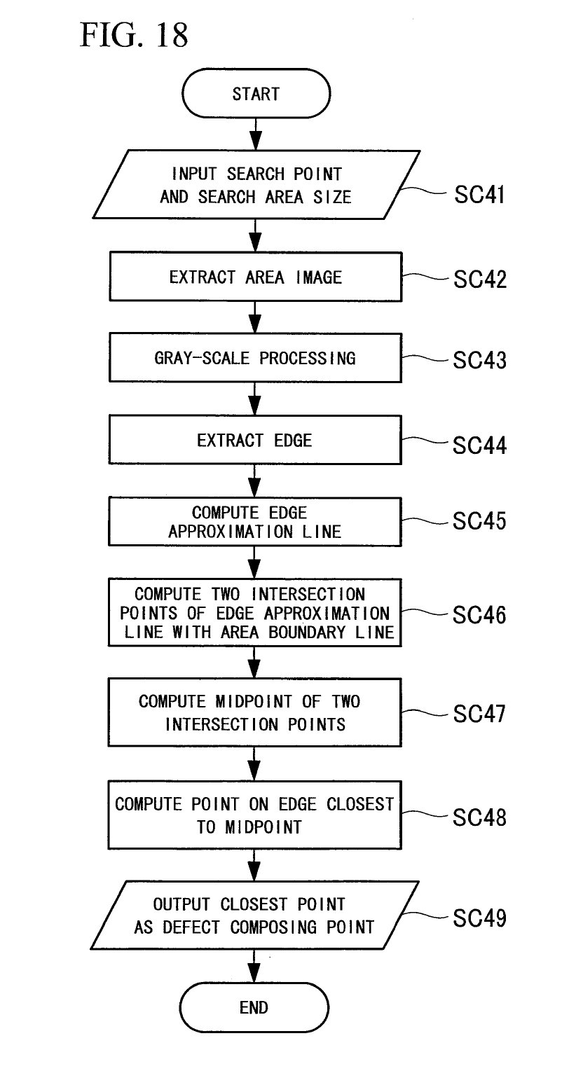

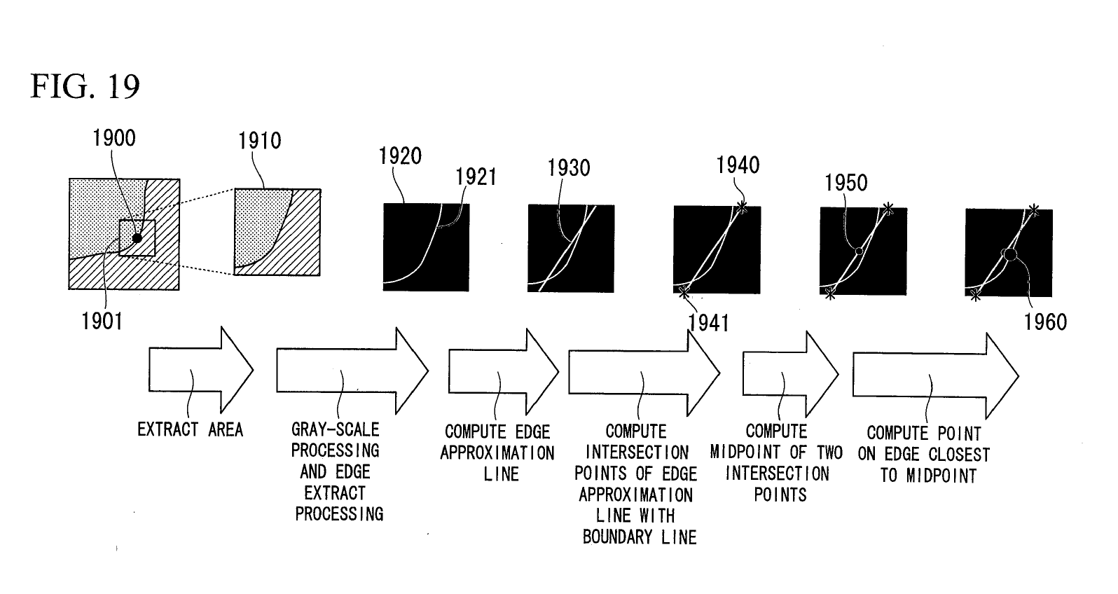

Next, a procedure of the defect composing point computation processing (Step SC4) will be described with reference to FIG. 18. Further, FIG. 19 schematically shows the procedure, so appropriate reference is made also to FIG. 19. When the image coordinates of the search points and the size of the search areas are input from the control section 18a (Step SC41), the defect composing point computation section 18d extracts area images of the search areas based on the image coordinates of the search points and the size of the search areas that have been input (Step SC42). As a result, an area image 1910 of a search area 1901 including a search point 1900 is extracted for each search point.

Subsequently, the defect composing point computation section 18d performs gray-scale processing on the extracted area image (Step SC43), and then performs an edge extraction on the gray-scale image (Step SC44). As a result, an edge 1921 is extracted from an image 1920 that is a gray-scaled version of the area image 1910. Subsequently, the defect composing point computation section 18d computes an approximation line of the extracted edge (Step SC45), and then computes two intersection points of the computed edge approximation line with boundary lines of the search area (Step SC46). As a result, an edge approximation line 1930 is computed, and intersection points 1940, 1941 of the edge approximation line 1930 with the boundary lines of the search area are computed.

Subsequently, the defect composing point computation section 18d computes a midpoint of the two computed intersection points (Step SC47), and then computes a point on the edge that is closest to the computed midpoint (Step SC48). As a result, a midpoint 1950 of the intersection points 1940, 1941 is computed, and a point 1960 on the edge that is closest to the midpoint 1950 is computed. Lastly, the defect composing point computation section 18d sets the computed closest point as a defect composing point, and outputs its image coordinates to the control section 18a (Step SC49).

In the gray-scale processing in Step SC43, a luminance value Y of each pixel in the image represented by the RGB components is computed by use of, for example, the following Equation (4).

Y=0.299×R+0.587×G+0.114×B (4)

There are cases where a defect (burning) as a measurement target has a characteristic color. Therefore, a luminance value of the characteristic color, for example, a luminance value of R (red), may be treated as a luminance value Y of the pixel. Based on video signals made of the computed luminance values Y, the edge extraction is performed in Step SC44.

To compute an edge approximation line after the edge extraction in Step SC44, it is preferable to employ, for the edge extraction, processing that produces as little noise as possible in the edge-extracted image. For example, the primary differential filter such as the Sobel filter, the Prewitt filter, or the Gradient filter, or the secondary differential filter such as the Laplacian filter may be used. In addition, processing in which expansion/contraction/difference processing, a noise reduction filter, and the like are combined may be used to perform the edge extraction. At this time, the gray-scale images are required to be binarized. A fixed value may be used as the binarization threshold value. Alternatively, the threshold value may be varied based on the luminance of the gray-scale image by using the percentile method, the mode method, the discriminant analysis method, and the like.

In the computation of an edge approximation line in Step SC45, the approximation line is computed based on the information on the edges extracted in Step SC44 by use of, for example, the least-square method. In the above, a line approximation is performed on the edge shape. However, a curve approximation by using a quadratic function or higher may be performed. In the case where the edge shape is closer to a curve than a line, the curve approximation enables a more accurate computation of a defect composing point.

In the output of the defect composing points in Step SC49, when defect composing points have not been computed properly in the previous processing in Steps SC42 to SC48 (for example, the edge extraction or the approximation lines have not been computed properly), the image coordinates of the search points may be output as image coordinates of defect composing points.

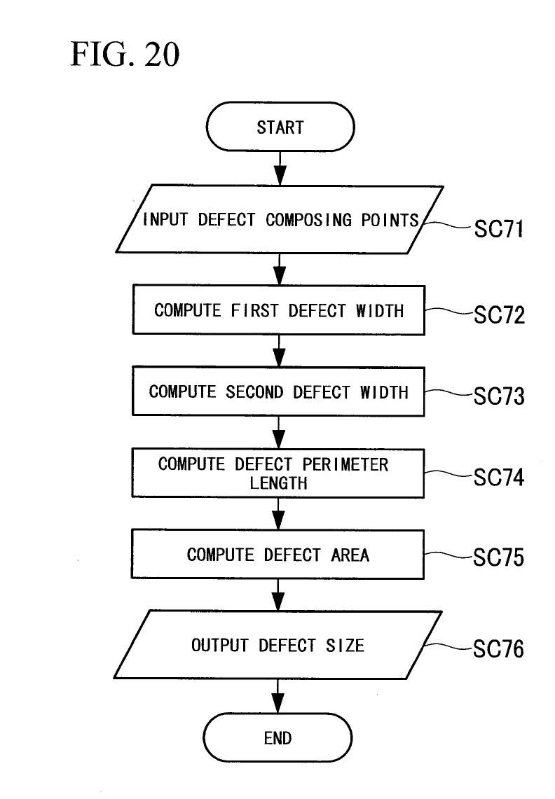

Next, a procedure of the defect size computation processing (Step SC7) will be described with reference to FIG. 20. When the spatial coordinates of the defect composing points are input from the control section 18a (Step SC71), the defect size computation section 18e computes a first width of the defect (Step SC72). The first width is a spatial distance between the two defect composing points that correspond to the first and second base points specified by the user. Subsequently, the defect size computation section 18e computes a second width of the defect (Step SC73). The second width is a spatial distance between the two defect composing points that correspond to the two search points on the line generally orthogonal to the base line.

Subsequently, the defect size computation section 18e computes a perimeter length of the defect (Step SC74). The perimeter length is a sum total of spatial distances between all the adjacent defect composing points. Subsequently, the defect size computation section 18e computes an area of the defect (Step SC75). The area is a spatial area of a region surrounded by all the defect composing points. Subsequently, the defect size computation section 18e outputs the computed defect size to the control section 18a (Step SC76).

As described above, the specification of the three base points by the user enables measurement of the defect size. Therefore, compared with the conventional case where a multitude of (for example, ten or more) base points are specified, the burden of operation can be reduced to improve operability. Furthermore, the details of the defect size can be found by computing at least two parameters as parameters denoting the defect size.

### First Embodiment

Next is a description of a first embodiment of the present invention. An endoscope apparatus of the present embodiment has a defect diagnosis function that not only computes a size of a detected defect in the above-described manner but is also capable of diagnosing whether the detected defect is of a problem or not. The configuration of the endoscope apparatus according to the present embodiment is as shown in FIG. 1, the difference lying in the configuration of the measurement processing portion 18.

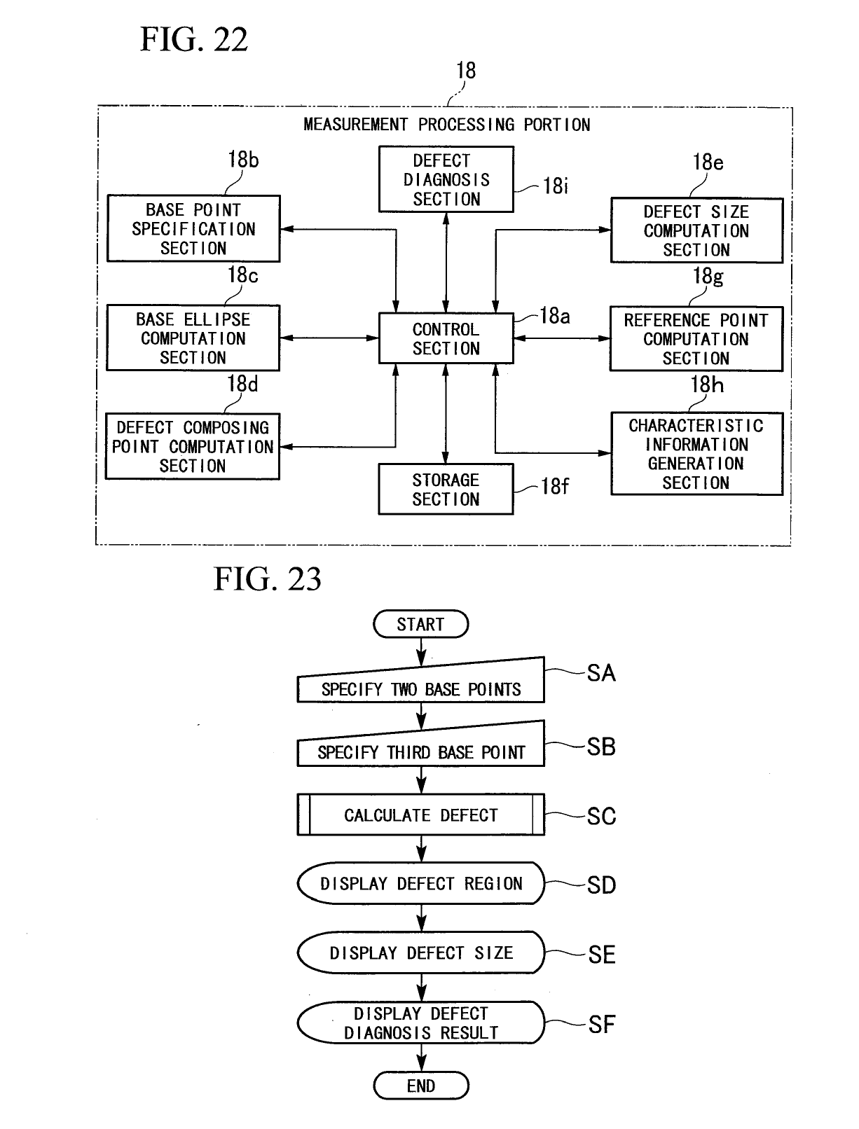

FIG. 22 shows a configuration of the measurement processing portion 18 of the present embodiment. As shown in FIG. 22, the measurement processing portion 18 includes: a control section 18a; a base point specification section 18b; a base ellipse computation section 18c; a defect composing point computation section 18d; a defect size computation section 18e; a storage section 18f; a reference point computation section 18g; a characteristic information generation section 18h; and a defect diagnosis section 18i.

The control section 18a, the base point specification section 18b, the base ellipse computation section 18c, the defect composing point computation section 18d, the defect size computation section 18e, and the storage section 18f are the same as those described above. The reference point computation section 18g sets reference points functioning as datums of positions for extracting characteristic information (luminance or color information in the present embodiment), which shows the characteristics of an image used for a defect diagnosis, and computes image coordinates of the reference points. In the present embodiment, a region formed by the defect composing points computed by the defect composing point computation section 18d is regarded as a defect region, and reference points are set inside and outside the defect region. The characteristic information generation section 18h generates characteristic information on an image at positions that are based on the reference points. The defect diagnosis section 18i determines whether the characteristic information satisfies a predetermined criterion, to thereby perform a defect diagnosis for diagnosing whether the defect is of a problem or not.

Next, a procedure of measurement in the present embodiment will be described. FIG. 23 shows the procedure of measurement. The difference from the procedure of measurement shown in FIG. 8 lies in the detailed procedure of the defect calculation (Step SC), and also in that processing of displaying a defect diagnosis result (Step SF) is added after the processing of displaying the defect size (Step SE).

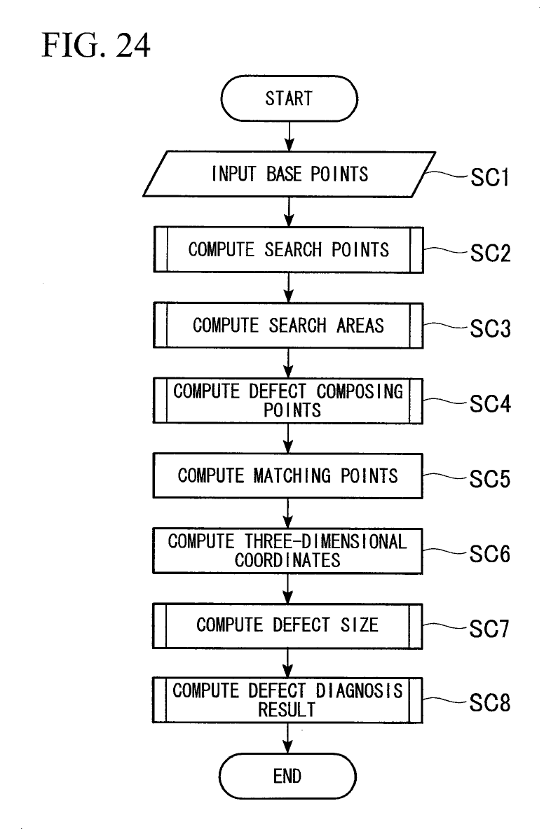

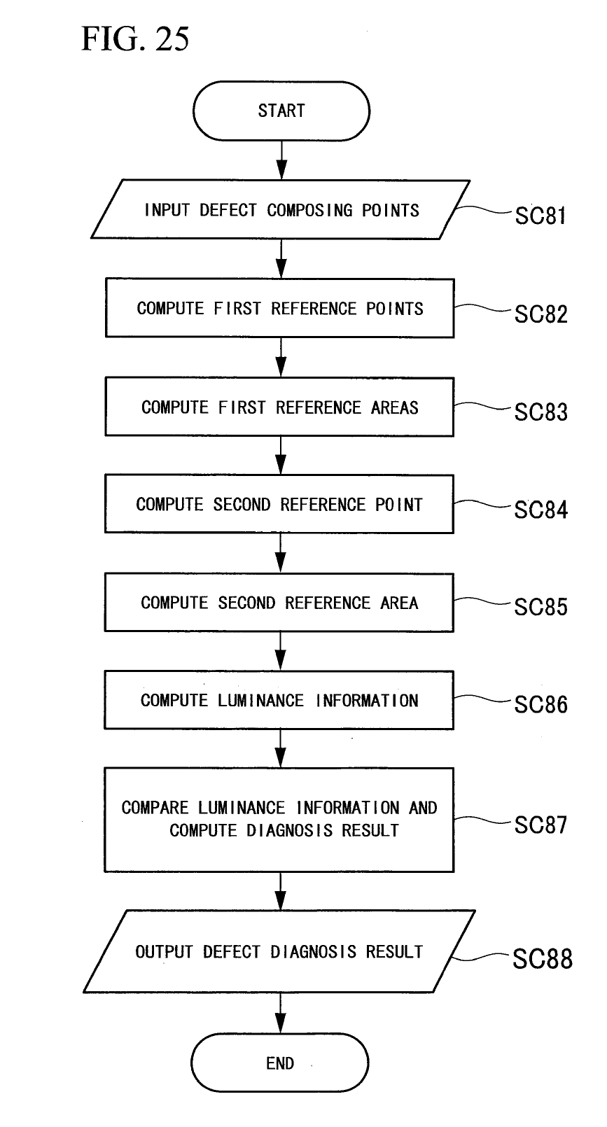

FIG. 24 shows the procedure of the defect calculation (Step SC). The difference from the procedure of the defect calculation shown in FIG. 13 lies in that processing of computing a defect diagnosis result (Step SC8) is added after the processing of computing the defect size (Step SC7). Hereunder is a description of the processing of computing the defect diagnosis result (Step SC8) with reference to FIG. 25.

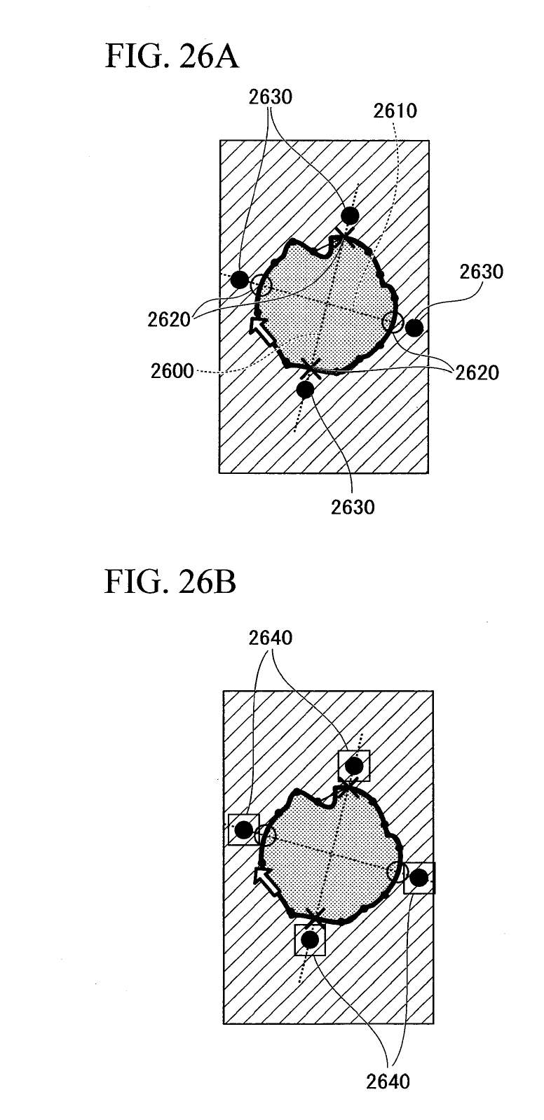

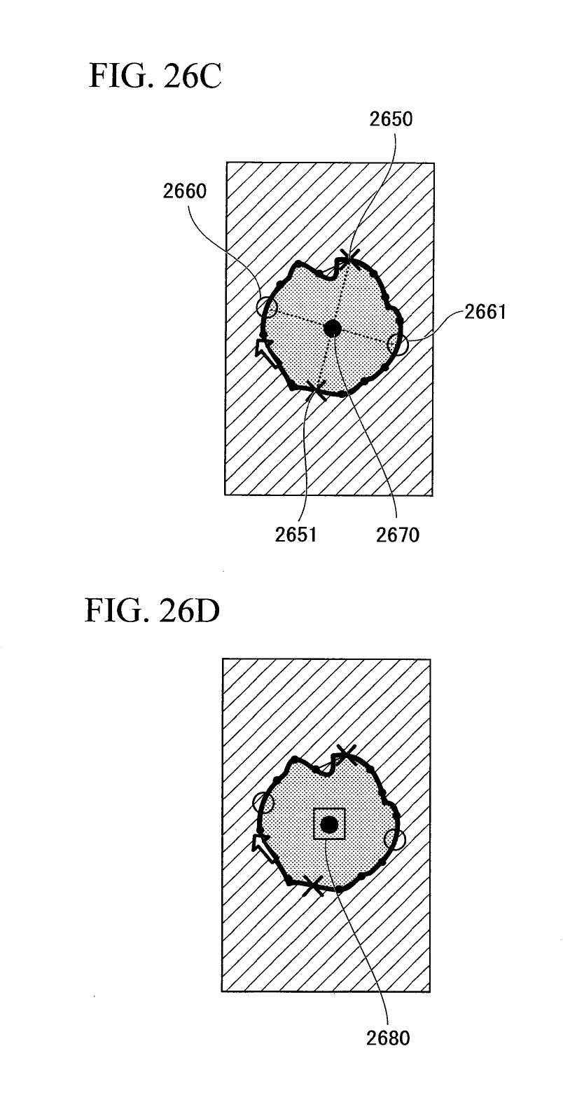

When the image coordinates of the defect composing points computed by the defect composing point computation section 18d is input from the control section 18a (Step SC81), the reference point computation section 18g computes image coordinates of first reference points (Step SC82). As shown in FIG. 26A, the first reference points are four points 2630 which are on a base line 2600 and on a line 2610 generally perpendicular to the base line 2600 (i.e., a line which represents the second width), and each of which is outside its corresponding defect composing point 2620 by a predetermined distance.

Subsequently, the reference point computation section 18g computes image coordinates of first reference areas (Step SC83). As shown in FIG. 26B, the first reference areas are four rectangular image-processing ranges 2640 each of which centers on its corresponding point 2630, that is, the first reference point. The first reference areas are used for computation of color information around the defect.

Subsequently, the reference point computation section 18g computes image coordinates of a second reference point (Step SC84). As shown in FIG. 26C, the second reference point is a point 2670 that is located at the gravity center of four points, that is, base points 2650, 2651 and defect composing points 2660, 2661, the defect composing points 2660, 2661 forming the width in the direction generally orthogonal to the base line 2610.

Subsequently, the reference point computation section 18g computes image coordinates of a second reference area (Step SC85). As shown in FIG. 26D, the second reference area is a rectangular image-processing range 2680 which centers on the point 2670, that is, the second reference point. The second reference area is used for the computation of color information inside the defect. Through the processing of Steps SC82 to SC85, the reference points and the reference areas are set inside and outside the defect area formed by the defect composing points.

Subsequently, the characteristic information generation section 18h uses the image data to compute luminance information on each reference area (Step SC86). At this time, the luminance information is computed as an average of luminance values Y of pixels in each reference area, the luminance value Y being obtained from the RGB components of the pixels. The luminance value Y is expressed by the following Equation (5).

Y=0.299×R+0.587×G+0.114×B (5)

Subsequently, the defect diagnosis section 18i compares pieces of luminance information on the reference areas, and diagnoses the defect based on the comparison result (Step SC87). Letting the average of the luminance information on the four first reference areas be Ya, and the luminance information on the second reference area be Yb, the luminance difference D as a difference between the two pieces of luminance information is expressed by the following Equation (6).

D=|Ya−Yb| (6)

When the luminance difference D is not less than a predetermined value, the defect diagnosis section 18i regards the luminance difference between the inside and the surroundings of the defect as high, and determines that the diagnosis result is not good. When the luminance difference D is less than the predetermined value, the defect diagnosis section 18i regards the luminance difference as low, and determines that the diagnosis result is OK.

Subsequently, the defect diagnosis section 18i outputs the defect diagnosis result to the control section 18a (Step SC88). On completion of the computation processing of the defect diagnosis result, which includes the above processing of Steps SC81 to SC88, the defect diagnosis result is displayed on the measurement screen through the instruction of the measurement processing portion 18 (Step SF of FIG. 23).

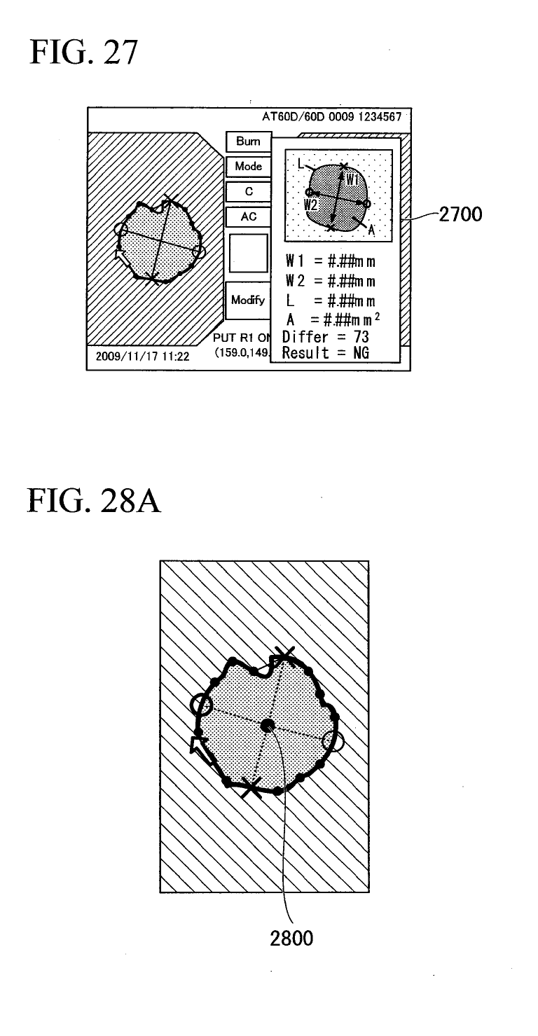

FIG. 27 shows a measurement screen when the measurement result and the diagnosis result of the defect are displayed. Two reference points (“x” marks) specified by the user and defect composing points (unfilled circles and filled circles) computed based on the reference points are displayed on the left screen. A result window 2700 is displayed on the right screen. The defect size (the first width W1, the second width W2, the perimeter length L, and the area A) as well as the difference between the pieces of luminance information (Differ) and the defect diagnosis result (Result) are displayed in the lower portion of the result window 2700. Based on the defect size and the diagnosis result, the user can check whether the detected defect is of a problem or not.

Next is a description of a first modification of the present embodiment. In the above, the luminance information on the reference areas is used. However, in the present modification, color information on the reference areas is used. As the color information, xy values used in the xy chromaticity diagram are used. The relationships between the RGB values and the xy values are expressed as the following Equations (7) and (8).

x=0.60×R−0.28×G−0.32×B (7)

y=0.20×R−0.52×G−0.31×B (8)

As a value for denoting a difference in color information, a distance between sets of coordinates in the xy chromaticity diagram is used. Letting the average color information on the four first reference area be xa and ya, and the color information on the second reference area be xb and yb, the difference D in the two pieces of color information is as the following Equation (9). The present modification is effective for the case where, between the inside and the surroundings of the defect, there is only a color difference with a small difference in luminance.

D=\sqrt{(xₐ−x_{b})²+(yₐ−y_{b})²} (9)

Next is a description of a second modification of the present embodiment. In the above, the first reference points outside the defect and the second reference point inside the defect are found based on the base points. However, in the present modification, a second reference point inside the defect is first found based on the base points, and first reference points are then found based on the second reference point and defect composing points.

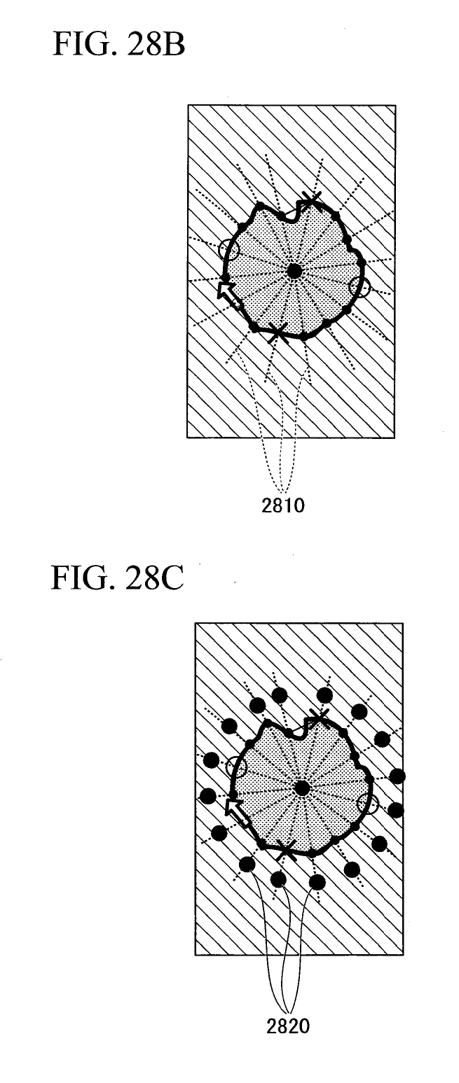

First, as shown in FIG. 28A, the reference point computation section 18g finds a second reference point 2800 in a similar manner to the above. Then, as shown in FIG. 28B, the reference point computation section 18g finds lines 2810 connecting the second reference point 2800 with defect composing points. Then, as shown in FIG. 28C, the reference point computation section 18g computes points 2820, each of which is located on the corresponding line 2810 and is outside the defect region at positions spaced a predetermined distance away from the corresponding defect composing point, as first reference points. The present modification is effective for the case where the luminance information around the defect is intended to be used in a wider range (more first reference points are intended to be set).

As described above, according to the present embodiment, the difference in luminance information on the reference areas including the reference points inside and outside the defect region, and the measurement result are displayed. Therefore, when the user visually observes a measurement target to determine whether the defect is of a problem or not, it is possible to notify the user of information that assists the determination. The present embodiment is effective when a diagnosis is made on a defect such as burning that has a characteristic difference between the inside and outside of the defect region.

Furthermore, with the determination whether the characteristic information on the image satisfies a predetermined criterion or not, to be more specific, whether the difference in luminance information is not less than a predetermined value or not, it is possible to determine whether the defect is of a problem or not, based on an objective criterion. In addition, with the display of the determination result, it is possible to notify the user of an objective determination result for the defect.

Furthermore, with the generation of luminance information as characteristic information on the image, it is possible to obtain information suitable for making a determination about a defect when the defect has a characteristic in luminance (i.e., there is a difference in luminance between the inside and outside of the defect). Alternatively, with the generation of color information as characteristic information on the image, it is possible to obtain information suitable for making a determination about a defect when the defect has a characteristic in color (i.e., there is a difference in color between the inside and outside of the defect).

Furthermore, defect composing points constituting an edge of a defect are computed based on the three base points specified by the user, and reference points and reference areas are set and characteristic information is generated based on the defect composing points. Thereby, while reducing the effort by the user, it is possible to generate characteristic information suitable for making a determination about a defect.

### Second Embodiment

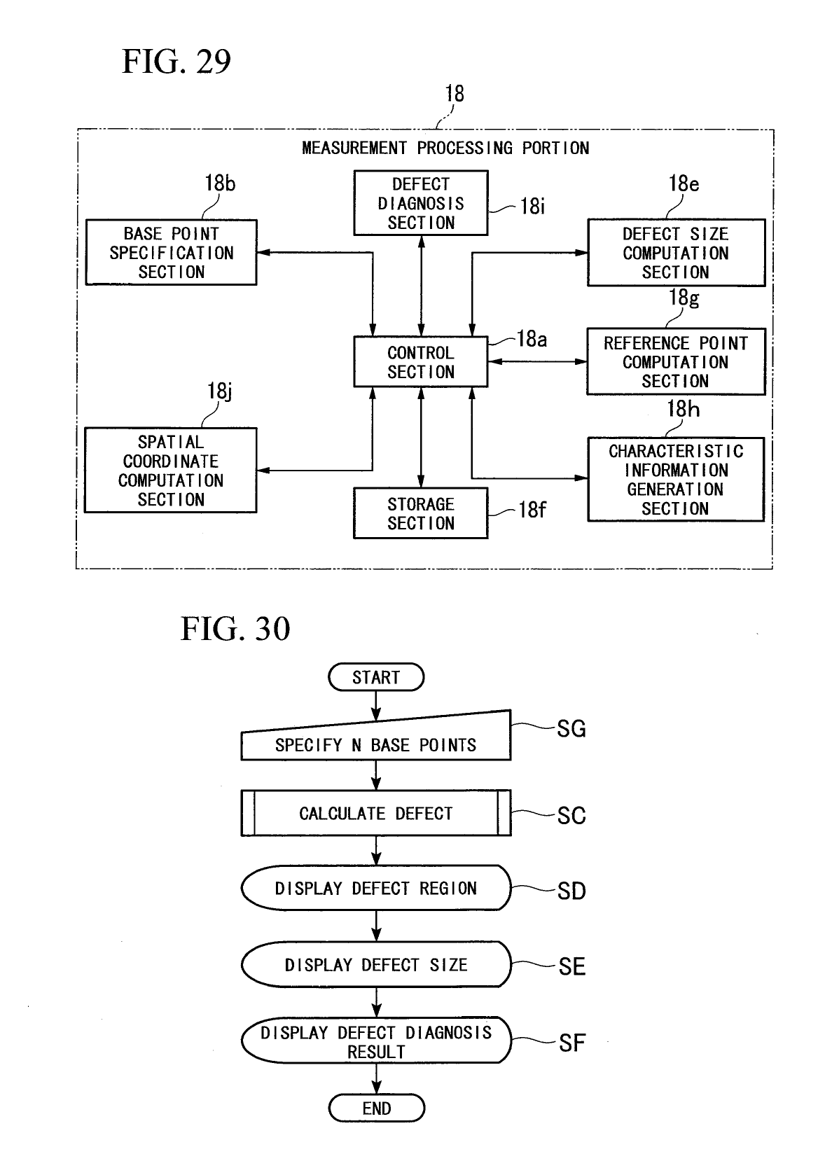

Next is a description of a second embodiment of the present invention. The configuration of an endoscope apparatus according to the present embodiment is as shown in FIG. 1, the difference lying in the configuration of the measurement processing portion 18. FIG. 29 shows a configuration of the measurement processing portion 18 of the present embodiment. As shown in FIG. 29, the measurement processing portion 18 includes: a control section 18a; a base point specification section 18b; a defect size computation section 18e; a storage section 18f; a reference point computation section 18g; a characteristic information generation section 18h; a defect diagnosis section 18i; and a spatial coordinate computation section 18j. The configuration shown in FIG. 29 is different form the configuration shown in FIG. 22 in that the base ellipse computation section 18c and the defect composing point computation section 18d are deleted and that the spatial coordinate computation section 18j is added. The spatial coordinate computation section 18j computes matching points that correspond to base points specified by the base point specification section 18b, and further computes spatial coordinates of the base points based on the base points and their matching points. The spatial coordinate computation section 18j is equivalent to a combination of a computation function for matching points and a computation function for spatial coordinates in the defect composing point computation section 18d.

Next, a procedure of measurement in the present embodiment will be described. FIG. 30 shows the procedure of measurement. The difference from the procedure shown in FIG. 23 lies in the detailed procedure of the defect calculation (Step SC) and also in that the processing of specifying three base points (Steps SA, SB) is changed to the processing of specifying n (n≧3) base points (Step SG).

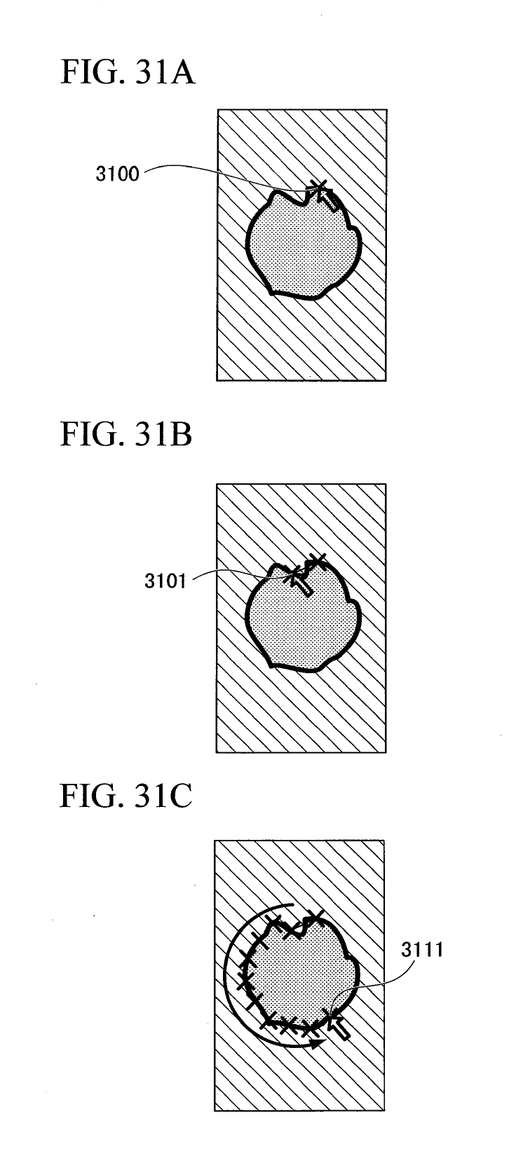

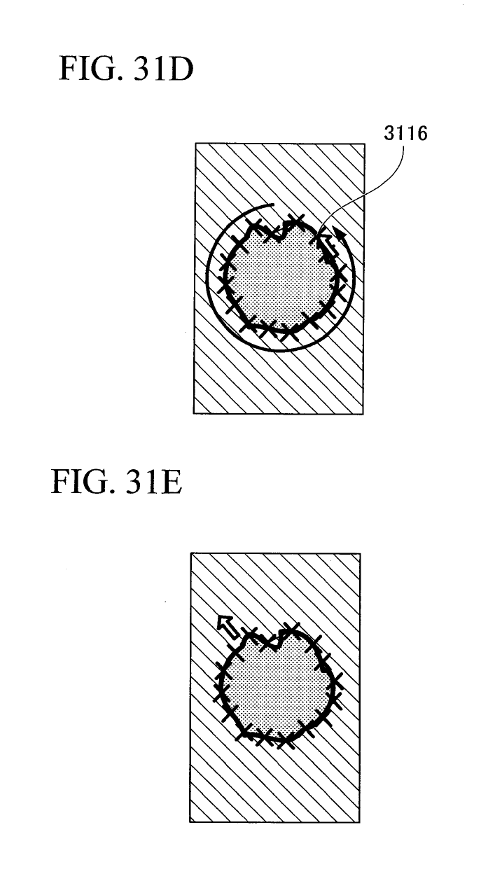

Hereunder is a description of the procedure of processing of specifying n base points (Step SG) with reference to FIGS. 31A to 31E. As shown in FIG. 31A, the user specifies a point 3100 on an edge of a defect as a first base point. When the position information on the base point specified by the user is input to the measurement processing portion 18, the base point specification section 18b computes image coordinates of the base point. Similarly, every time a base point is specified by the user, the base point specification section 18b computes image coordinates of the base point.

Subsequently, as shown in FIG. 31B, the user specifies a point 3101, on the edge of the defect, in the vicinity of the point 3100 as a second base point. Subsequently, as shown in FIG. 31C, the user sequentially specifies points on the edge of the defect counterclockwise. In this case, the specification direction is counterclockwise. However, the user may sequentially specify base points clockwise. FIG. 31C shows a state in which a point 3111 as an 11th base point has been specified.

Furthermore, as shown in FIG. 31D, the user sequentially specifies points on the edge of the defect counterclockwise. FIG. 31D shows a state in which a point 3116 as a 16th base point is specified. After specifying the point 3116 in the vicinity of the first-specified point 3100, the user specifies a point at which the region formed by the 16 points specified as base points closes, as shown in FIG. 31E. When the (n+1)th point is specified and the line connecting between the first point and the second point intersects the line connecting between the nth point and the (n+1)th point, the (n+1)th point is defined as a “point at which the region closes.”

The base point specification section 18b computes image coordinates of the points specified as the base points. Furthermore, the base point specification section 18b computes the above two lines to determine whether the lines intersect each other or not. When the lines intersect each other, the base point specification section 18b determines that the specification of the base points has been completed, and outputs, to the control section 18a, the image coordinates of the base points except the point at which the region closes. In the above example, sixteen base points are specified. However, the number of the base points is not limited to sixteen.

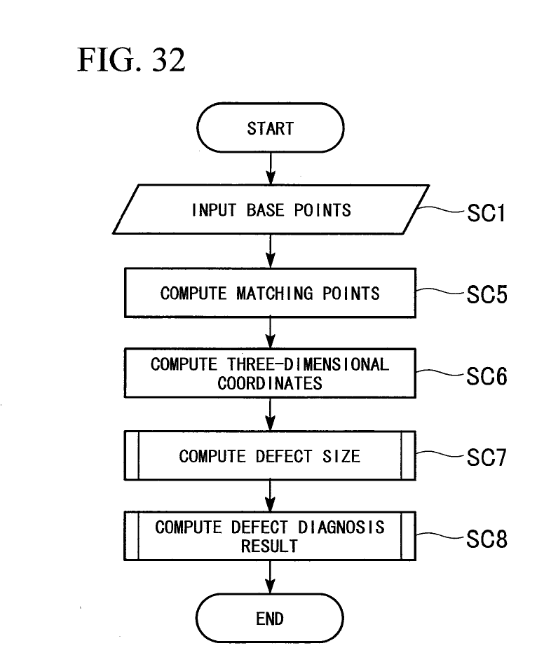

Next, a procedure of the defect calculation (Step SC) will be described with reference to FIG. 32. When the image coordinates of the base points computed by the base point specification section 18b are input from the control section 18a (Step SC1), the spatial coordinate computation section 18j computes image coordinates of matching points that correspond to the base points (Step SC5). Subsequently, the spatial coordinate computation section 18j computes spatial coordinates (three-dimensional coordinates in the actual space) of the base points based on the image coordinates of the base points and their matching points (Step SC6).

Subsequently, the defect size computation section 18e computes a defect size based on the computed spatial coordinates (Step SC7). The defect size in the present embodiment includes a perimeter length and an area of the defect. The perimeter length is a sum total of spatial distances between all the adjacent base points. The area is a spatial area of a region surrounded by all the base points. Subsequently, processing of computing a defect diagnosis result is performed (Step SC8).

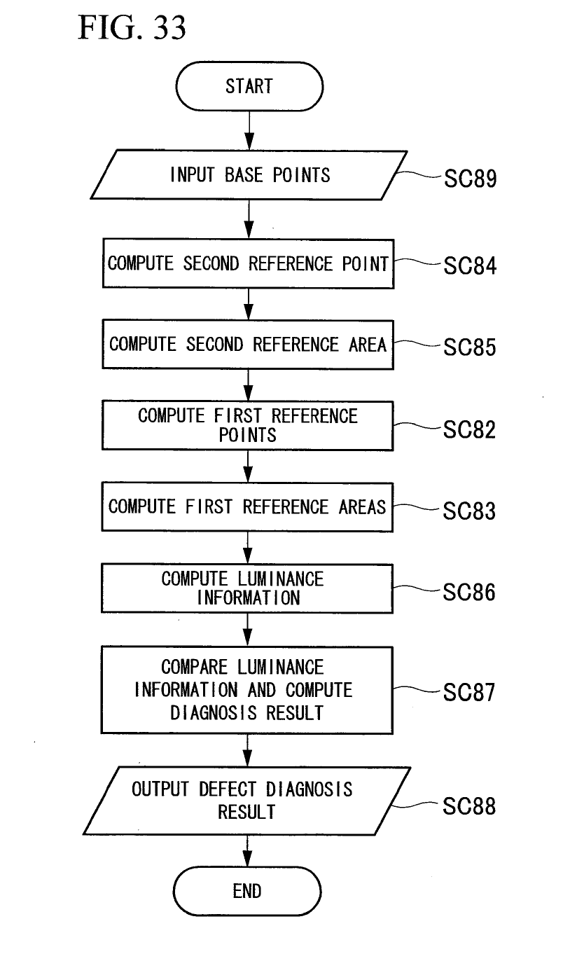

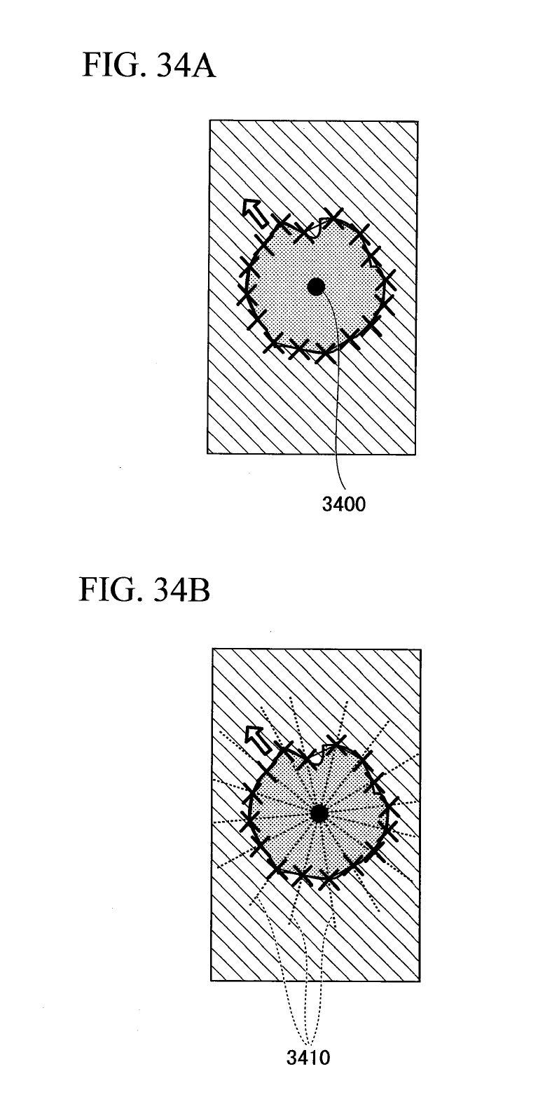

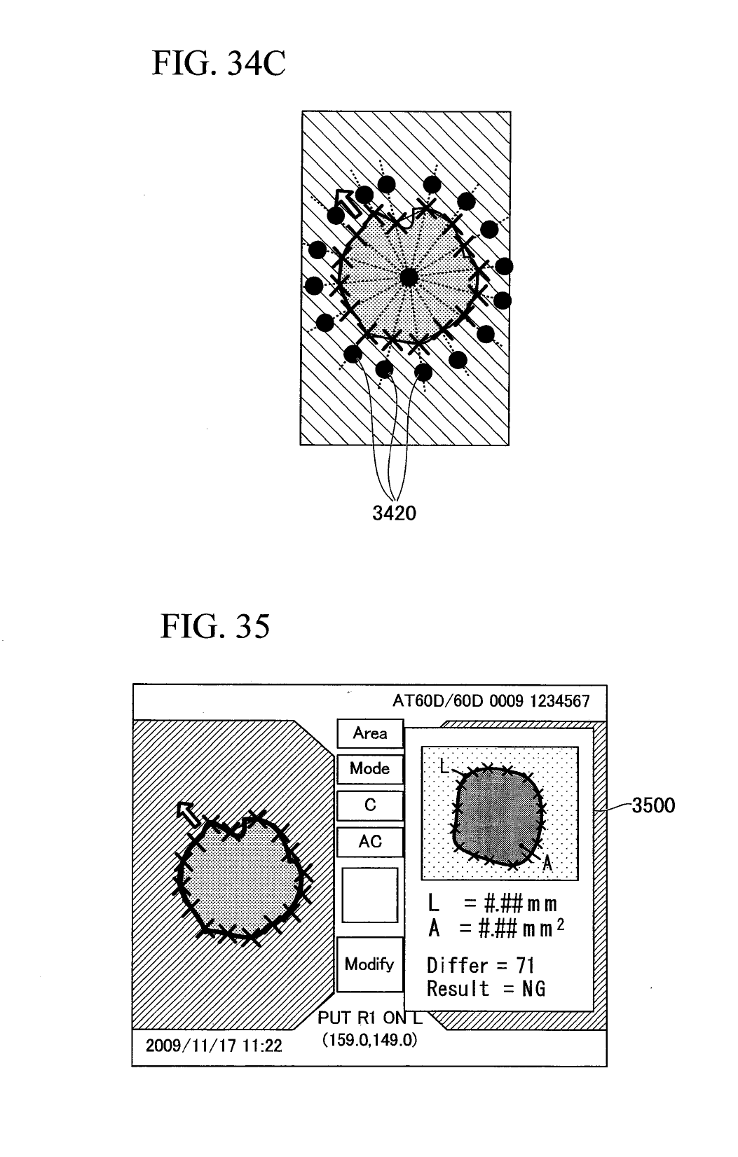

Next, a procedure of computation processing of the defect diagnosis result (Step SC8) will be described with reference to FIG. 33. When the image coordinates of the base points are input from the control section 18a (Step SC89), the reference point computation section 18g computes image coordinates of a second reference point (Step SC84). As shown in FIG. 34A, the second reference point is a point 3400 located at the gravity center of the sixteen base points.

Subsequently, the reference point computation section 18g computes image coordinates of a second reference area centering on the second reference point (Step SC85). Subsequently, the reference point computation section 18g computes image coordinates of first reference points (Step SC82). At this time, as shown in FIG. 34B, the reference point computation section 18g finds lines 3410 connecting the point 3400 as the second reference point with each base point. Then, as shown in FIG. 34C, the reference point computation section 18g finds points 3420, each of which is located on the corresponding line 3410 and is outside the defect region at positions spaced a predetermined distance away from the corresponding base point, as first reference points. Subsequently, the reference point computation section 18g computes image coordinates of first reference areas centering on the first reference points (Step SC83). Processing of Steps SC86 to SC88 subsequent to Step SC83 is similar to that of FIG. 25.

FIG. 35 shows a measurement screen when a measurement result and a diagnosis result of the defect are displayed. Sixteen reference points (“x” mark) specified by the user are displayed on the left screen. A result window 3500 is displayed on the right screen. The defect size (the perimeter length L, the area A) as well as the difference between the pieces of luminance information (Differ) and the defect diagnosis result (Result) are displayed in the lower portion of the result window 3500. Based on the defect size and the diagnosis result, the user can check whether the detected defect is of a problem or not.

As described above, according to the present embodiment, when the user visually observes a measurement target to determine whether the defect is of a problem or not, it is possible to notify the user of information that assists the determination, similarly to the first embodiment. Furthermore, since the user can specify a plurality of base points on an edge of a defect, it is possible to perform a measurement that reflects the intention of the user. In addition, if the defect has a complex shape, measurement accuracy improves.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

According to the present invention, characteristic information on an image at reference points set inside and outside a region, and a result of measurement at base points are displayed. Therefore, when the user visually observes a subject to make a determination about the subject, it is possible to notify the user of information that assists the determination.

What is claimed is:

1. An endoscope apparatus, comprising:
an imaging unit that captures a subject to acquire an image of the subject;
a control unit that includes:
a base point setting section that sets base points on the image, the base points being used for a three dimensional measurement of the subject;
a reference point setting section that sets reference points inside and outside a region based on the base points, the reference points being used for extracting a characteristic of the image;
a measurement section that performs the three dimensional measurement of the subject based on the base points; and
a generation section that generates characteristic information indicating a characteristic of the image at the reference points based on information on the image at the reference points; and
a display that displays the image, the characteristic information, and a result of the three dimensional measurement.

2. The endoscope apparatus according to claim 1, wherein the control unit further includes a determination section that determines whether the characteristic information satisfies a predetermined criterion or not.

3. The endoscope apparatus according to claim 2, wherein:
the generation section generates: first characteristic information indicating a characteristic of the image at the reference point that is set inside the region; and second characteristic information indicating a characteristic of the image at the reference point that is set outside the region; and
the determination section determines whether a difference between the first characteristic information and the second characteristic information satisfies a predetermined criterion or not.

4. The endoscope apparatus according to claim 2, wherein the display further displays a result of determination by the determination section.

5. The endoscope apparatus according to claim 1, wherein the generation section generates the characteristic information based on luminance information on the image at the reference points.

6. The endoscope apparatus according to claim 1, wherein the generation section generates the characteristic information based on color information on the image at the reference points.

7. The endoscope apparatus according to claim 1, wherein the control unit further includes a composing point setting section that sets composing points based on the base points, the composing points constituting the region and being more numerous than the base points,
wherein the reference point setting section sets the reference points inside and outside a region based on the composing points.

8. The endoscope apparatus according to claim 1, wherein the reference point setting section sets the reference points inside and outside a region formed only of the base points.

9. A measurement method comprising the following steps of:
acquiring an image of a subject;
setting base points on the image, the base points being used for a three dimensional measurement of the subject;
setting reference points inside and outside a region based on the base points, the reference points being used for extracting a characteristic of the image;
performing the three dimensional measurement of the subject based on the base points;
generating characteristic information showing a characteristic of the image at the reference points based on information on the image at the reference points; and
displaying the image, the characteristic information, and a result of the three dimensional measurement.
